(19) United States
(12) Patent Application Publication
(10) Pub. No.: US 2026/0169457 A1
(43) Pub. Date: Jun. 18, 2026

(54) SYSTEMS AND METHODS FOR AUTOMATION CONTROL

(71) Applicant: Pipeline Design & Engineering, LLC, Tempe, AZ (US)

(72) Inventors: Aaron Moncur, Mesa, AZ (US); Aaron Robison, Phoenix, AZ (US); Ruben Inzunza, Mesa, AZ (US); Mark Blakey, Phoenix, AZ (US); Jason Farris, Gilbert, AZ (US)

(21) Appl. No.: 19/416,828

(22) Filed: Dec. 11, 2025

Related U.S. Application Data
(60) Provisional application No. 63/733,262, filed on Dec. 12, 2024.

(51) Int. Cl. G05B 19/25; G05B 19/409; G06F 3/0486

(52) U.S. Cl. CPC G05B 19/25; G05B 19/409; G06F 3/0486

(57) ABSTRACT

Disclosed herein, are systems and methods for generating one or more motion sequences, and/or actuating one or more motion devices according to the motion sequences. The systems and methods may be implemented in an automation environment. The motion sequences may be generated, via a software module, using one or more modular function blocks, each of which may be defined based on one or more parameters. The motion sequences may be generated, and/or the modular function blocks may be defined, graphically using a user interface (e.g., a graphical user interface (GUI)). The motion devices may include any number of motor controlled devices and/or any number of pneumatic controlled devices. Each motion device may be coupled to a respective motion controller, wherein the motion controller is configured to receive the motion sequences via communication with the software module, so as to actuate movement by the motion devices.

### CROSS-REFERENCE TO RELATED APPLICATIONS

The present application claims priority to U.S. Provisional Patent Application No. 63/733,262; filed on Dec. 12, 2024; entitled “MOTION CONTROL SOFTWARE WITH INTEGRATED HARDWARE;” the entire disclosure of which is incorporated by reference herein.

### TECHNICAL FIELD

The present disclosure relates to automation control systems, including motion control systems.

### BACKGROUND

Motion control automation typically requires extensive programming knowledge and significant integration efforts between software and hardware. Typical systems have a complex interface for configuring and controlling multiple actuators and motors and require specialized training for use.

### SUMMARY OF THE INVENTION

The disclosure includes a system comprising a motor controller configured to control motion of a motor-powered device, and a software program communicatively coupled to the motor controller. In some embodiments, the software program comprises an interface configured to receive at least one user input to thereby instruct the motor controller to move the motor-powered device.

The disclosure includes a system comprising a pneumatic controller configured to control motion of a pneumatic-powered device, and a software program communicatively coupled to the pneumatic controller. In some embodiments, the software program comprises an interface configured to receive at least one user input to thereby instruct the pneumatic controller to move the pneumatic-powered device.

Described herein, in some aspects, is a system, comprising a controller configured to actuate movement of a motion device; one or more processors; and one or more memories storing instructions that, when executed by the one or more processors, cause the system to perform operations comprising: generating a motion sequence, by: defining, via communication with the controller, one or more function blocks for the motion sequence, each function block defined by one or more parameters; and receiving an input for the one or more parameters of each function block of the one or more function blocks; and sending, to the controller, instructions relating to the one or more parameters, so as to actuate the movement of the motion device in accordance with the motion sequence.

In some embodiments, each function block of the one or more function blocks corresponds to an action performed by the i) the controller, ii) the motion device, iii) an external component coupled with the controller, or iv) any combination thereof, such that the one or more function blocks correspond to one or more actions. In some embodiments, each action comprises a motion action, a conditional action, a wait action, a repeat action, or any combination thereof.

In some embodiments, the motion sequence is generated via modularly arranging the one or more function blocks in a hierarchical order, via a graphical user interface. In some embodiments, the hierarchical order corresponds to a sequential performance of the corresponding one or more actions. In some embodiments, modularly arranging the one or more function blocks comprises a drag-and-drop configuration.

In some embodiments, receiving the input for each parameter of the one or more parameters is via i) input received from a user, ii) automatically correlated with the parameter based on preconfigured initialized data, or iii) both. In some embodiments, the preconfigured initialized data corresponds to a property relating to the controller, the motion device, a device coupled to the controller, or any combination thereof. In some embodiments, the initialized data comprise a numerical value, a limit for a parameter of the one or more parameters, a listing of available options for the parameter, or any combination thereof. In some embodiments, preconfigured initialized data comprises a real-time binding with function block defined for the motion sequence, such that changes to the preconfigured initialized data are automatically changed for the corresponding function block.

In some embodiments, the controller comprises a motor controller, a pneumatic controller, or both. In some embodiments, the motion device comprises a motor controlled device in communication with the motor controller. In some embodiments, the motor controlled device comprises a linear slide, a rotary index, or both. In some embodiments, the action comprises a motion action, the motion action comprising a movement of the linear slide, a rotation of the rotary index, or both. In some embodiments, the limit for the parameter of claim 9 comprises a maximum travel length of the linear slide. In some embodiments, the motor controller comprises one or more axes, each axis interchangeably configurable with a linear slide and a rotary index. In some embodiments, the listing of available options as described herein comprises the motor controlled device configured with an axis of the motor controller. In some embodiments, the input comprises a corresponding axis for the motion device, a motion type, an absolute target position, units of measurement for a motion, speed, acceleration, direction of motion, rotation speed, rotation amount, rotation units, timeout duration, encoder presence, gear ratio or pitch, steps per revolution, home switch configuration, homing method, or any combination thereof.

In some embodiments, the motion device comprises a pneumatic controlled device in communication with the pneumatic controller. In some embodiments, the pneumatic controlled device comprises a pneumatic cylinder. In some embodiments, the action comprises a motion action, the motion action comprising an extension or retraction of the pneumatic cylinder. In some embodiments, the pneumatic controller comprises one or more actuators, each actuator configurable with a corresponding pneumatic cylinder. In some embodiments, the listing of available options as described herein comprises the pneumatic controlled device configured with an actuator of the pneumatic controller. In some embodiments, the input comprises cylinder selection, extension or retraction action by the cylinder, pressure condition, or any combination thereof.

In some embodiments, the controller is communicatively coupled with the external component, wherein at least one function block of the one or more function blocks corresponds to an action performed by the external component. In some embodiments, the listing of available options of claim 9 corresponds to a listing of available connectivity ports disposed on the controller, wherein the external component is coupled to a connectivity port of the available connectivity ports. In some embodiments, the external component comprises a sensor.

In some embodiments, the system further comprises one or more additional motion devices, wherein the controller is configured to actuate movement of the one or more additional motion devices in accordance with the motion sequence, such that each additional motion device corresponds to at least one function block of the one or more function blocks. In some embodiments, each additional motion device comprises any motion device described herein.

In some embodiments, the system further comprises one or more additional controllers and one or more additional motion devices, each additional motion device corresponding to a respective additional controller, such that each additional controller is configured to actuate movement of the corresponding motion device in accordance with the motion sequence, the operations further comprising: defining for each additional controller, via communication with each additional controller, one or more additional function blocks, each additional function block defined by one or more parameters; and receiving an input for the one or more parameters of each additional function block of the one or more additional function blocks; and sending, to each additional controller, instructions relating to the one or more parameters, so as to actuate the movement of the respective additional motion device in accordance with the motion sequence.

In some embodiments, the one or more processors are communicatively coupled to the controller and each additional controller via a daisy-chain linkage. In some embodiments, sending the instructions to each additional controller comprises sending the same instructions to the controller and each additional controller, wherein each controller is configured to parse the instructions to extract only those instructions relating the respective motion device.

In some embodiments, for any system described herein, the instructions for the motion sequence is sent as executable code, the instructions generated via a no-coding graphical user interface.

Described herein in other aspects, is a method comprising: selecting a desired controller, wherein the controller is configured to actuate movement of a motion device, the controller communicatively coupled with a software module via one or more processors; generating a motion sequence for the motion device, via the software module, by: modularly arranging one or more function blocks in a hierarchical order, via a graphical user interface, wherein each function block of the one or more function blocks corresponds to an action performed by i) the controller, ii) the motion device, iii) an external component coupled to the controller, or iv) any combination thereof, and defining each function block via one or more corresponding parameters, wherein data for each parameter of the one or more corresponding parameters is i) received via input from a user, ii) automatically correlated based on initialized data associated with the parameter, or iii) both; and sending the motion sequence to the desired controller, for actuating the movement of the motion device.

In some embodiments, the method further comprises initializing the generating of the motion sequence by preconfiguring at least some of the one or more parameters with corresponding initialized data, where the at least some of the one or parameters relate to the controller, the motion device, an external component coupled to the controller, or any combination thereof. In some embodiments, the method further comprises automatically correlating the initialized data in real-time with the modularly arranged one or more function blocks. In some embodiments, the method further comprises verifying the one or more parameters for accuracy, completeness, or both, prior to the movement of the motion device being actuated.

In some embodiments, the software module comprises an error module configured to i) detect, ii) receive, or iii) both, an error signal, the error module configured to prevent actuation of the movement of the motion device until the error signal is removed. In some embodiments, each action comprises a motion action, a conditional action, a wait action, a repeat action, or any combination thereof.

In some embodiments, the hierarchical order corresponds to a sequential performance of the corresponding one or more actions. In some embodiments, modularly arranging the one or more function blocks comprises a drag-and-drop configuration.

In some embodiments, the controller is a motor controller, a pneumatic controller, or both. In some embodiments, the motion device comprises a motor controlled device in communication with the motor controller. In some embodiments, the motor controlled device comprises a linear slide, a rotary index, or both. In some embodiments, the action comprises a motion action, the motion action comprising a movement of the linear slide, a rotation of the rotary index, or both. In some embodiments, the initialized data comprises a limit for the parameter comprising a maximum travel length of the linear slide. In some embodiments, the motor controller comprises one or more axes, each axis interchangeably configurable with a linear slide and a rotary index. In some embodiments, the data comprises a corresponding axis for the motion device, a motion type, an absolute target position, units of measurement for a motion, speed, acceleration, direction of motion, rotation speed, rotation amount, rotation units, timeout duration, encoder presence, gear ratio or pitch, steps per revolution, home switch configuration, homing method, or any combination thereof.

In some embodiments, the motion device comprises a pneumatic controlled device in communication with the pneumatic controller. In some embodiments, the pneumatic controlled device comprises a pneumatic cylinder. In some embodiments, the action comprises a motion action, the motion action comprising an extension or retraction of the pneumatic cylinder. In some embodiments, the data comprises cylinder selection, extension or retraction action by the cylinder, pressure condition, or any combination thereof.

In some embodiments, the controller is communicatively coupled with the external component, wherein at least one function block of the one or more function blocks corresponds to an action performed by the external component. In some embodiments, the external component comprises a sensor.

Described herein, in other aspects, is a non-transitory computer readable medium for moving a motion device, the non-transitory computer readable medium comprising instructions that, when executed by a processor, cause the processor to perform operations comprising: selecting a desired controller, wherein the controller is configured to actuate movement of a motion device, the controller communicatively coupled with a software module via the processor; generating a motion sequence for the motion device, via the software module, by: modularly arranging one or more function blocks in a hierarchical order, via a graphical user interface, wherein each function block of the one or more function blocks corresponds to an action performed by i) the controller, ii) the motion device, iii) an external component coupled to the controller, or iv) any combination thereof, and defining each function block via one or more corresponding parameters, wherein data for each parameter of the one or more corresponding parameters is i) received via input from a user, ii) automatically correlated based on initialized data associated with the parameter, or iii) both; and sending the motion sequence to the desired controller, for actuating the movement of the motion device.

In some embodiments, the operations further comprises initializing the generating of the motion sequence by preconfiguring at least some of the one or more parameters with corresponding initialized data, where the at least some of the one or parameters relate to the controller, the motion device, an external component coupled to the controller, or any combination thereof. In some embodiments, the operations further comprises automatically correlating the initialized data in real-time with the modularly arranged one or more function blocks. In some embodiments, the operations further comprises verifying the one or more parameters for accuracy, completeness, or both, prior to the movement of the motion device being actuated.

In some embodiments, the software module comprises an error module configured to i) detect, ii) receive, or iii) both, an error signal, the error module configured to prevent actuation of the movement of the motion device until the error signal is removed. In some embodiments, each action comprises a motion action, a conditional action, a wait action, a repeat action, or any combination thereof.

In some embodiments, the hierarchical order corresponds to a sequential performance of the corresponding one or more actions. In some embodiments, modularly arranging the one or more function blocks comprises a drag-and-drop configuration. The controller is a motor controller, a pneumatic controller, or both. In some embodiments, the motion device comprises a motor controlled device in communication with the motor controller. In some embodiments, the motor controlled device comprises a linear slide, a rotary index, or both. In some embodiments, the action comprises a motion action, the motion action comprising a movement of the linear slide, a rotation of the rotary index, or both. In some embodiments, the initialized data comprises a limit for the parameter comprising a maximum travel length of the linear slide. In some embodiments, the motor controller comprises one or more axes, each axis interchangeably configurable with a linear slide and a rotary index. In some embodiments, the data comprises a corresponding axis for the motion device, a motion type, an absolute target position, units of measurement for a motion, speed, acceleration, direction of motion, rotation speed, rotation amount, rotation units, timeout duration, encoder presence, gear ratio or pitch, steps per revolution, home switch configuration, homing method, or any combination thereof.

In some embodiments, the motion device comprises a pneumatic controlled device in communication with the pneumatic controller. In some embodiments, the pneumatic controlled device comprises a pneumatic cylinder. In some embodiments, the action comprises a motion action, the motion action comprising an extension or retraction of the pneumatic cylinder. In some embodiments, the data comprises cylinder selection, extension or retraction action by the cylinder, pressure condition, or any combination thereof.

In some embodiments, the controller is communicatively coupled with the external component, wherein at least one function block of the one or more function blocks corresponds to an action performed by the external component. In some embodiments, the external component comprises a sensor.

Described herein, in other aspects, is a system, comprising a controller configured to actuate an output for a component; one or more processors; and one or more memories storing instructions that, when executed by the one or more processors, cause the system to perform operations comprising: generating an automation sequence, by: defining, via communication with the controller, one or more function blocks for the automation sequence, each function block defined by one or more parameters; and receiving an input for the one or more parameters of each function block of the one or more function blocks; and sending, to the controller, instructions relating to the one or more parameters, so as to actuate the output for the component in accordance with the automation sequence.

In some embodiments, the component comprises a sensor. In some embodiments, the output comprises a trigger switch for actuation of a secondary component. In some embodiments, the secondary component comprises any motion device described herein, such that actuation of the secondary component comprises movement of the motion device.

Described herein, in other aspects, is a system, comprising: a motor controller configured to control motion of a motor-powered device; and a software program communicatively coupled to the motor controller, the software program comprising an interface configured to receive at least one user input to thereby instruct the motor controller to move the motor-powered device.

Described herein, in other aspects, is a system, comprising: a pneumatic controller configured to control motion of a pneumatic-powered device; and a software program communicatively coupled to the pneumatic controller, the software program comprising an interface configured to receive at least one user input to thereby instruct the pneumatic controller to move the pneumatic-powered device.

The foregoing, and other features and advantages of the invention, will be apparent from the following, more particular description of the preferred embodiments of the invention, the accompanying drawings, and the claims.

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a system including a software module and a motion controller, according to some embodiments.

FIG. 2A illustrates a front perspective a motor controller and a pneumatic controller, along with the respective motion devices, according to some embodiments.

FIG. 2B illustrates a front view of the motor controller and the pneumatic controller, along with the respective motion devices, of FIG. 2A, according to some embodiments.

FIG. 3A illustrates a top, front perspective view of a motor controller, according to some embodiments.

FIG. 3B illustrates a top, back perspective view of the motor controller, according to some embodiments.

FIG. 3C illustrates a first side view of the motor controller, according to some embodiments.

FIG. 3D illustrates a second side view of the motor controller, according to some embodiments.

FIG. 4A illustrates a front view of the motor controller, according to some embodiments.

FIG. 4B illustrates a back view of the motor controller, according to some embodiments.

FIG. 5 illustrates a top and interior view of the motor controller, according to some embodiments.

FIG. 6 illustrates a perspective interior view of the motor controller, according to some embodiments.

FIG. 7 illustrates a bottom view of the motor controller, according to some embodiments.

FIG. 8A illustrates a top, front perspective view of a pneumatic controller, according to some embodiments.

FIG. 8B illustrates a top, back perspective view of the pneumatic controller, according to some embodiments.

FIG. 9A illustrates a first side view of the pneumatic controller, according to some embodiments.

FIG. 9B illustrates a second side view of the pneumatic controller, according to some embodiments.

FIG. 10A illustrates a front view of the pneumatic controller, according to some embodiments.

FIG. 10B illustrates a back view of the pneumatic controller, according to some embodiments.

FIG. 11 illustrates a top view of the pneumatic controller, according to some embodiments.

FIG. 12 illustrates a bottom view of the pneumatic controller, according to some embodiments.

FIG. 13 illustrates a top and interior view of the pneumatic controller, according to some embodiments.

FIG. 14 illustrates a perspective interior view of the pneumatic controller, according to some embodiments.

FIG. 15 illustrates an example depiction of communicative coupling between components of a system, according to some embodiments.

FIG. 16 illustrates an example depiction of modules associated with the software module of a system, according to some embodiments.

FIG. 17 illustrates an example of a visual interface for a software module of a system, according to some embodiments.

FIG. 18 illustrates an example flow chart of a method for generating a motion sequence, according to some embodiments.

FIGS. 19A-19C illustrate an example of another visual interface with various selection options for a motion controller, according to some embodiments.

FIGS. 20A-20C illustrate an example of a visual interface depicting available parameters and components for various master blocks, according to some embodiments.

FIG. 21 illustrate an example of a initialize stage of a visual interface, according to some embodiments.

FIGS. 22A-25B illustrate an example of generating an automation sequence through defining function blocks with parameters, according to some embodiments.

FIGS. 26-29 illustrate example graphical user interfaces for a system, according to some embodiments.

### DETAILED DESCRIPTION OF THE INVENTION

The present invention relates to automation control systems, which may include motion control systems and/or sensor systems, and, more particularly, to a no-code programming platform integrated with motor and/or pneumatic controllers. The system simplifies, for example, the automation of motor-driven and pneumatic motion for various environments, including and not limited to research, development, and certain production environments.

Automation control systems, such as motion control systems, have a wide variety of applicable use cases. Examples include lifecycle testing (e.g., automates repetitive tasks such as durability testing of mechanical components), R&D or proof-of-concept automation (e.g., accelerates R&D workflows by allowing rapid iteration of motion designs), manufacturing process development (e.g., rapid testing and evaluation of motion and automation to define new processes for manufacturing environments), and/or production automation (e.g., streamlines simple manufacturing processes, such as pick-and-place operations).

Automation of motion control typically requires extensive programming knowledge and significant integration efforts between software and hardware. Conventional systems often lack a user-friendly interface for configuring and controlling multiple actuators and motors without specialized training. For example, conventional motion controllers, such as (for example) programmable logic controller (PLC) systems, programmable automation controller (PAC) systems, and computer numerical control (CNC) systems, have always required explicit programming languages such as ladder logic, structured text, or G-code. These systems were designed for trained controls engineers, rather than other personnel, such as R&D engineers. The architecture of those systems assumes the user can define input/output (I/O) addressing, memory registers, and timing logic manually. As a result, even small configuration changes for a given motion sequence, like adjusting a delay or reversing an axis, typically require code edits, recompilation, and redeployment.

Moreover, conventional systems lack a unified hardware platform. For example, conventional motion systems required custom wiring, power-supply sizing, and component selection (valves, drivers, encoders, terminal blocks). Every installation was bespoke, meaning the control software could not assume standard I/O mapping or signal behavior. Thus, without a pre-integrated hardware foundation, there was no way for a generic graphical user interface (GUI) to know what devices were present or how to talk to them automatically. This lack of standardization forced developers to keep user interfaces at the “expert” level, rather than simplifying them for non-programmers.

Accordingly, disclosed herein, are systems and methods for generating one or more automation sequences and/or actuating a device according to the automation sequence. One example of an automation sequence includes a motion sequence, which may include actuating movement of one or more devices (e.g., motion devices), and/or include other actions (which may not involve actual movement) as carried out (e.g., performed) by the device (e.g., motion device) and/or other components of the system (e.g., controller, input/output (I/O) device (e.g., an external component), as described herein). Other examples of an automation sequence include sensor integration, which may include trigger sequences that rely on a sensor signal (e.g., limit switch) prior to actuating an action (which may include a motion sequence as described herein, and/or other actions, such as alerts, permissive actions (e.g., unlocking), etc.)). For the purposes of this disclosure, motion sequences may be described throughout, but it should be noted that said disclosure may be applicable to sensor integration sequences as appropriate.

As such, disclosed herein, are systems and methods for generating one or more motion sequences, and/or actuating one or more devices (e.g., motion devices) according to the motion sequences. The systems and methods may be implemented in an automation environment. The motion sequences may be generated using one or more modular function blocks, each of which may be defined based on one or more parameters, which may be received via input from a user, automatically correlated with the respective parameter, or both. The motion sequences may be generated, and/or the modular function blocks may be defined, graphically using a user interface (e.g., a graphical user interface (GUI)). The motion sequence(s) may be generated via one or more processors. In some cases, the motion sequence(s) is generated using a software module (e.g., software application). The one or more processors may be provided with one or more computing devices.

The motion devices may include any number of motor controlled devices and/or any number of pneumatic controlled devices. Each motion device may be coupled to a respective motion controller, wherein the motion controller is configured to receive the motion sequences via communication with any of the processors, so as to actuate movement by the motion devices. Each pneumatic controlled device may include any number of pneumatic actuators, while each motor controlled device may include any number of motor axes.

In some embodiments, the system is provided as a kit, with the kit further including one or more pre-integrated motion controllers, wherein the software module is pre-configured with the one or more motion controllers, such that the software module is configured to automatically discover and register at least some of the motion devices, I/O devices (e.g., an external component, such as for example, a sensor, a switch, etc.), and other parameters associated with the respective motion controller(s) upon being communicatively coupled therewith. The pre-integrated motion controller may include an assembled controller with connected motion devices and/or I/O devices, as well as necessary components, so as to be ready to be connected to the software module for use. A pre-integrated motion controller with a software module may help reduce time spent sourcing and/or wiring components like power supplies, terminal blocks, and solenoid valves, where the pre-integrated motion controllers may support electric motors, pneumatic actuators, sensors, and other field devices for a seamless plug-and-play experience.

### System Overview

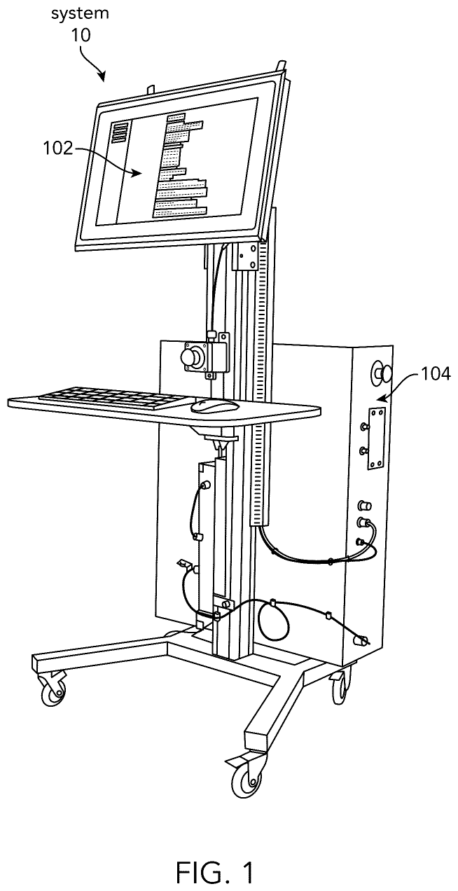

In some embodiments, a system described herein includes one or more software components, and one or more hardware components. The software component(s) may include a software module, while the hardware component(s) may include one or more motion controllers configured to be communicatively coupled with the software module. Other hardware components may include the motion devices, I/O devices (e.g., limit switches, sensors), valves, wiring, etc. The software module may be provided with and/or via one or more computing devices, each including one or more processors. FIG. 1 depicts an example system, including the software module as displayed (e.g., 102) using a processor(s), and a motion controller 104. The motion controller(s) 104 may be configured to receive data from, and/or transmit data to, the software module 102 (and/or vice versa).

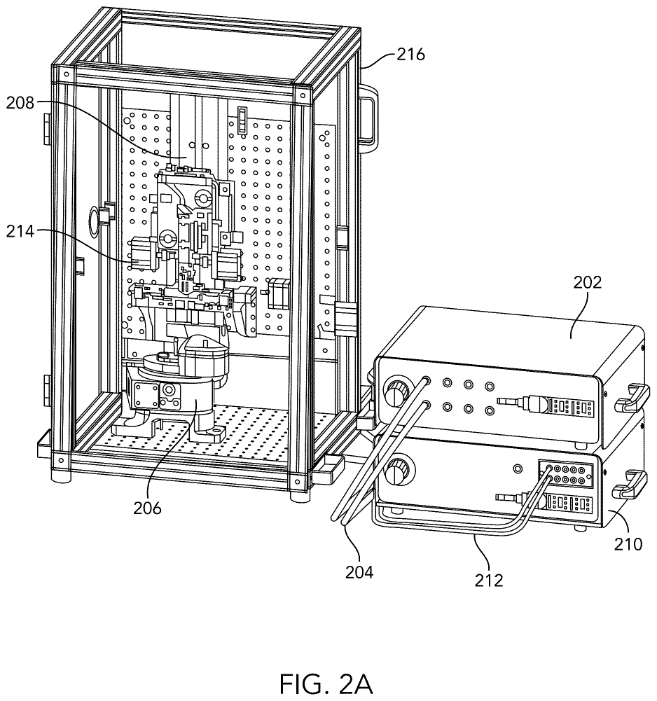

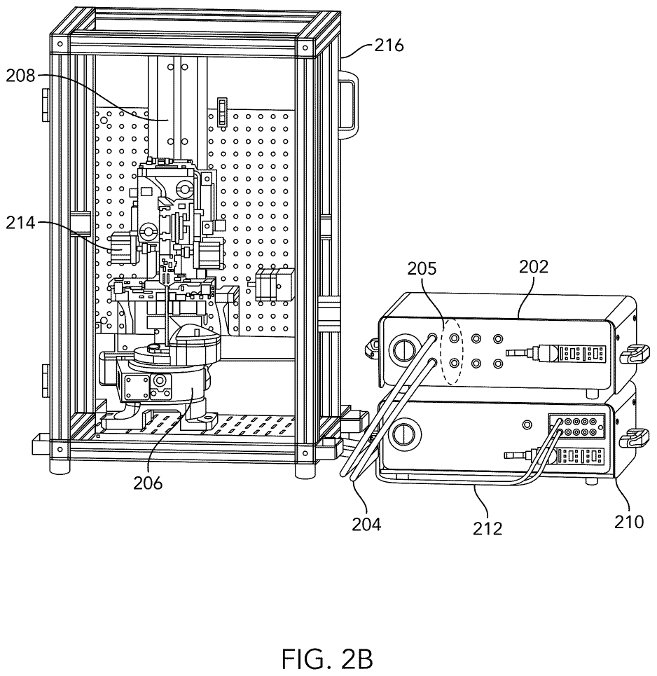

For any system described herein, examples of types of motion controllers include a motor controller, a pneumatic controller, a sensor controller (motor and/or pneumatic controllers may already include digital and/or analog I/O ports for sensor integration, but in some cases, a separate sensor controller may be used), etc. Each motion controller may be configured to be communicatively coupled and/or mechanically coupled with a motion device. FIGS. 2A-2B depict a perspective view and a front view, respectively, of two motion controllers 202, 210 and corresponding motion devices 206, 208, 214 coupled thereto. For example, motion controller 202 may be a motor controller that is configured to actuate movement of a rotary index 206 (an example of a motion device) and/or a linear slide 208 (another example of a motion device) via motor connection cable(s) 204. Specifically, the motor controller 202 may be configured to actuate the rotary index 206 to rotate a mechanical component (e.g., actuate a motor to enable rotation), and/or to actuate the linear slide 208 to move a mechanical component (e.g., actuate a motor to enable movement) along the slide (where the mechanical component may be the same or a different mechanical component for rotation via rotary index 206).

With continued reference to FIGS. 2A-2B, another example of a motion controller 210 may be a pneumatic controller that is configured to actuate movement of a mechanical component using a pneumatic cylinder 214 via connection cable(s) 212. The connection cable(s) 212 may include a compressible fluid, such as air, used to provide a pneumatic force.

Accordingly, each motion controller may be configured to actuate movement of one or more mechanical components via actuating one or more respective motion devices. Moreover, each motion controller may be configured to actuate movement of the one or more motion devices according to a motion sequence. Each motion sequence, which may be received as commands (e.g., instructions) from the software module, may be generated via one or more function blocks, each of which may include a specific sequential set of step(s). As described herein, each function block (e.g., specific sequence of steps) may correspond to a specific action, such as moving a linear slide, actuating a cylinder (e.g., pneumatic cylinder), a conditional action (e.g., if-then), a wait action, a repeat action, etc. (as described further herein). Thus, the specific action may not necessarily require an actual movement or actuation of a device.

Any motion controller (including any type, e.g., motor controller, pneumatic controller) described herein may include one or more components to help actuate movement of a motion device, as used in a system described herein. For example, any motion controller may include one or more processors configured to receive, process, and/or execute instructions from the software module, and transmit instructions to the software module. Any motion controller may include one or more sensors to help detect a particular condition (e.g., a distance of slide, a speed, a rotation, a pressure condition for pneumatic cylinder etc.). For example, any motion controller may include one or more digital inputs (which may include positive-negative-positive (PNP) inputs) for position sensors, limit switches, and/or external triggers. Alternatively or additionally, any motion controller may include one or more analog inputs for sensors providing continuous feedback (e.g., pressure, load, position). Any motion controller may include one or more digital outputs to activate external devices (e.g., glue valves, lights, solenoids). Any motion controller may include one or more analog outputs for controlling proportional valves and/or analog-driven peripherals.

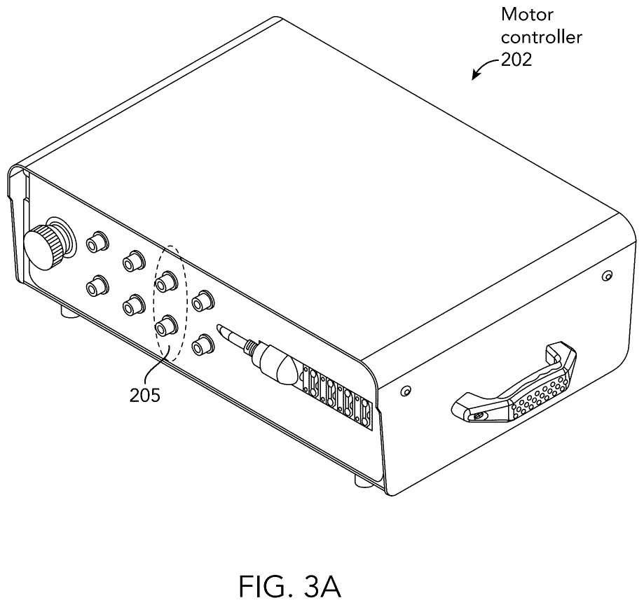

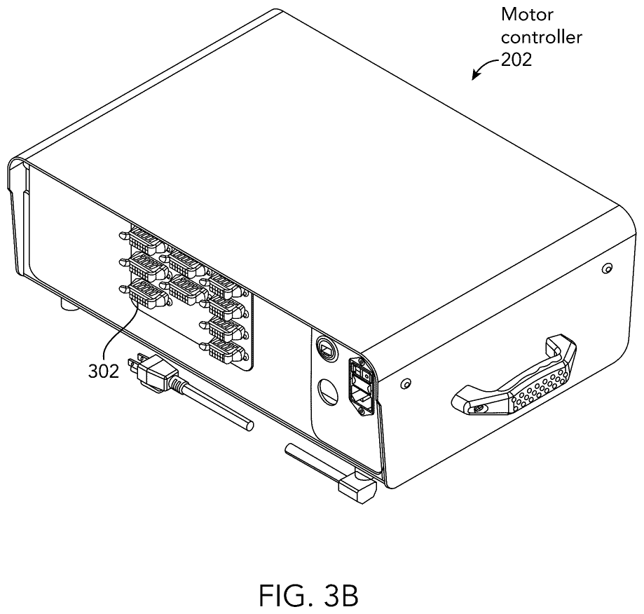

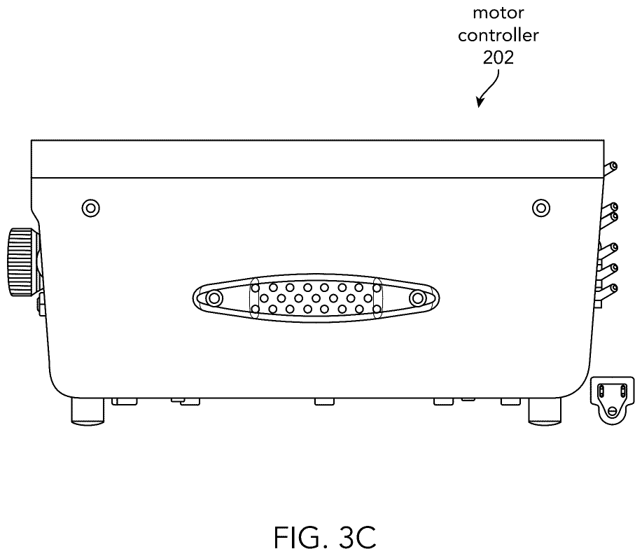

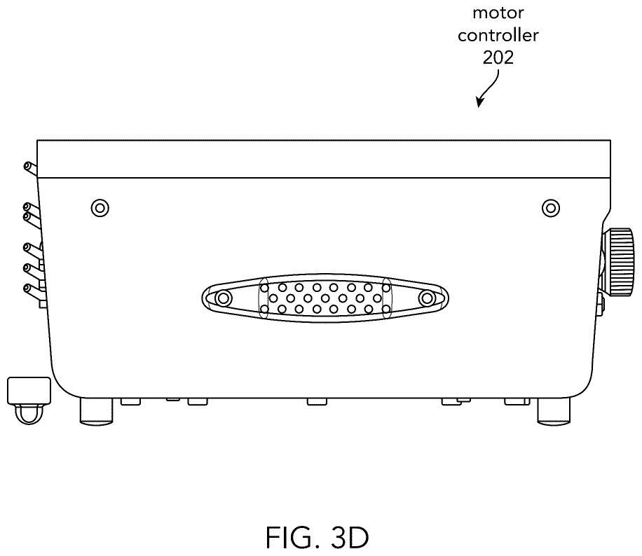

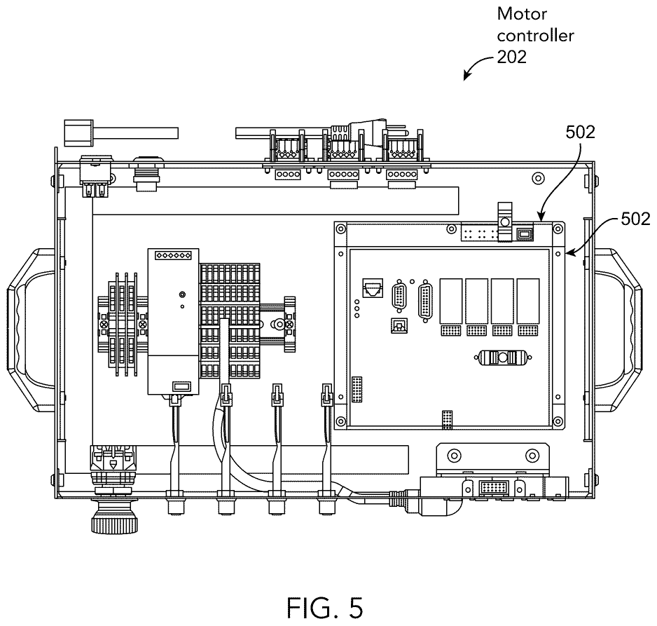

Moreover each type of motion controller may have specific components and/or configurations. FIGS. 3A-7 depict various views of an example motor controller 202. FIG. 3A depicts a perspective front view of the motor controller 202, where a number of ports 205 are depicted. Such ports, may for example, relate to motor cable receptacles (e.g., top row may be for power, and bottom row may be for motor encoder). As described herein, each motor controller 202 may be configured to actuate movement about any number of axes (e.g., four motor axes). For example, the motor controller may include a processor (e.g., as described herein, wherein the processor may be a computing controller 502 in FIG. 5), wherein the controller's processor(s) (e.g., 502) is configured to send commands (e.g., as received from the software module) to move the motor/s (e.g., motion devices). The motor controller may govern electrical power (voltages and amperage) required for the motor's (e.g., motion device's) motion.

As described herein, a motor axis may include a linear slide (e.g., 208) or rotary motor (e.g., 206). In some cases, each axis associated with a motor controller may be interchangeably used for a linear slide or a rotary motor. Any given motor axis may be a stepper motor, a servo motor, or a step/dir motor. The motor controller may include any number (e.g., four) motor output channels, which may be identical to each other. In some embodiments, each motor output channel may include a 4-pin M12 power connector supplying stepper-drive output, and/or an 8-pin M12 encoder connector for feedback. These outputs may be agnostic to the type of mechanical device attached—each may be able to drive a rotary motor directly or a linear actuator (such as a ballscrew slide or leadscrew stage). The control electronics may generate standard step-and-direction signals, so the same channel (e.g., output port) can control either motion type without rewiring or firmware changes.

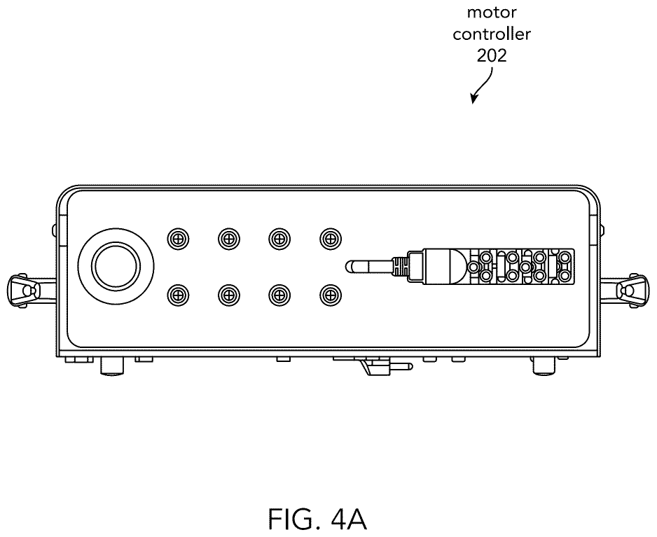

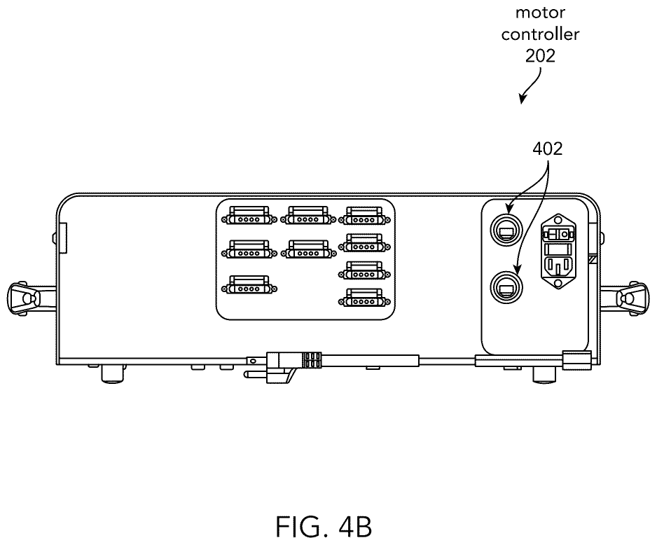

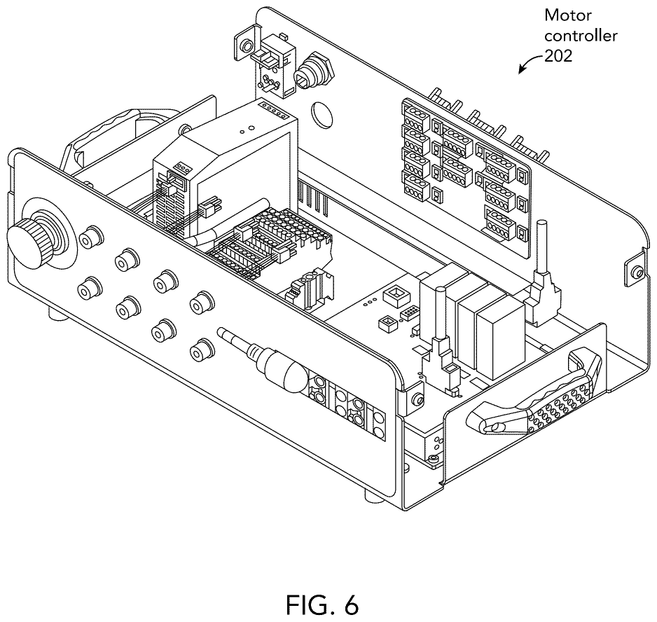

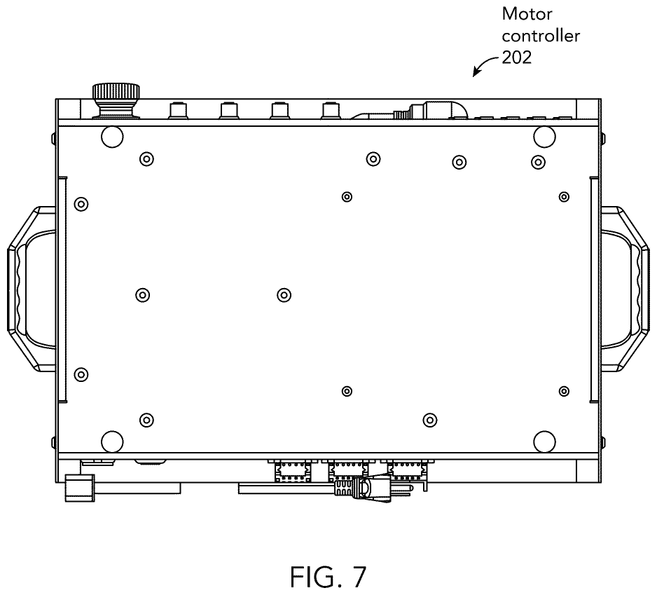

FIG. 3B depicts a perspective back view of the motor controller 202, depicting one or more ports 302, which may include input (e.g., digital, analog) and/or output (e.g., digital, analog) ports, as described herein. As described herein, each motion controller may be configured to transmit and receive data (e.g., from the software module, and/or to other motion controllers [regardless of type]). In some cases, such data transfer occurs via an Ethernet wire. FIGS. 3C-3D depict a first side and a second side view of the motor controller 202, respectively. FIGS. 4A-4B depict a front and back view of the motor controller 202, respectively. An example pair of Ethernet wire ports 402 is depicted in FIG. 4B. FIGS. 5-6 depict a top interior view, and a front perspective interior view of the motor controller 202, respectively, which include computing boards and/or other motor controller components. FIG. 7 depicts a bottom view of the motor controller 202.

The motor controller 202 may include one or more home/limit switch inputs (e.g., 8), one or more encoder inputs, one or more digital outputs (e.g., 4, 9), one or more digital inputs (e.g., 4, 9), one or more analog inputs and/or outputs (e.g., 4), or any combination thereof. In some embodiments, one or more I/O devices and/or sensors may be communicatively coupled to the motor controller 202 via any one of said inputs and/or outputs.

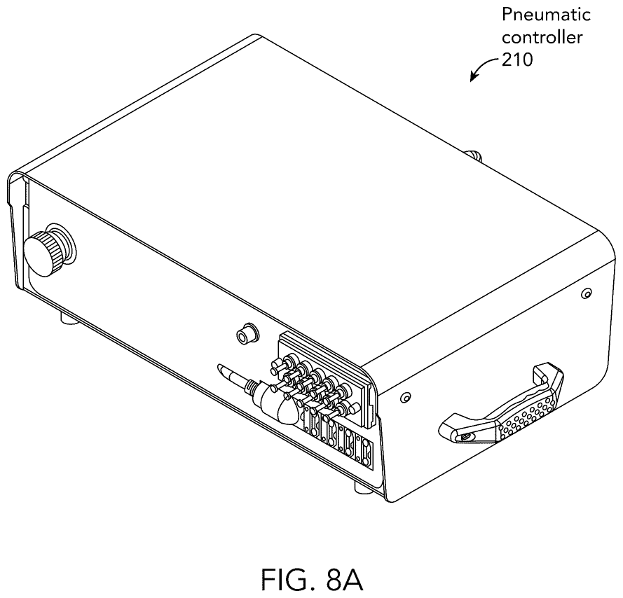

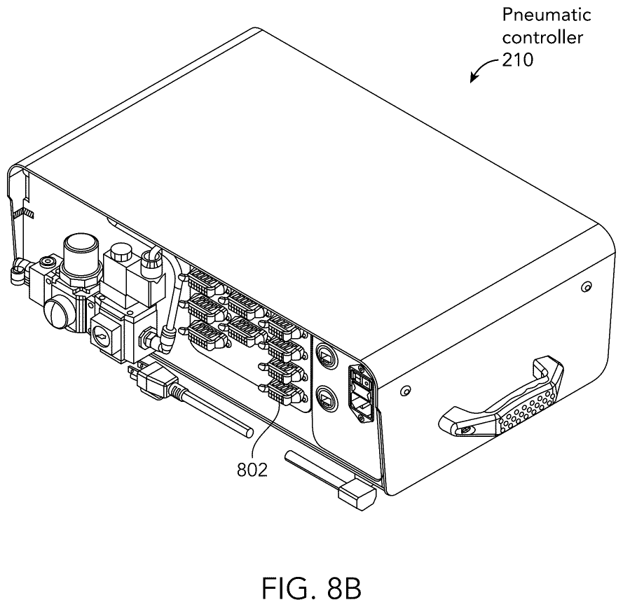

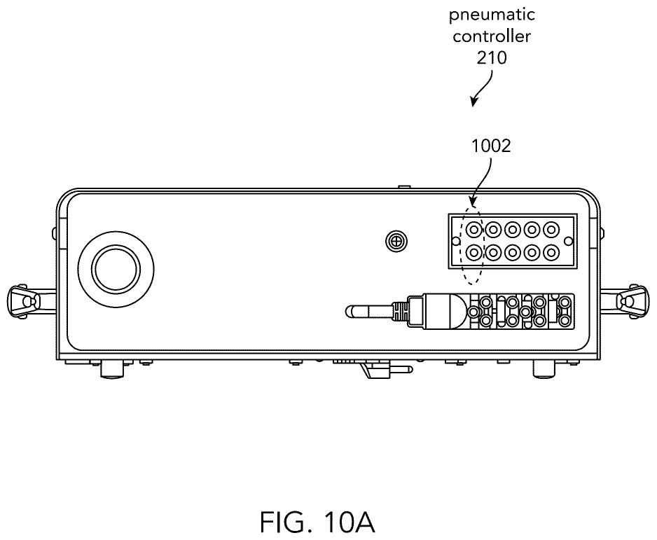

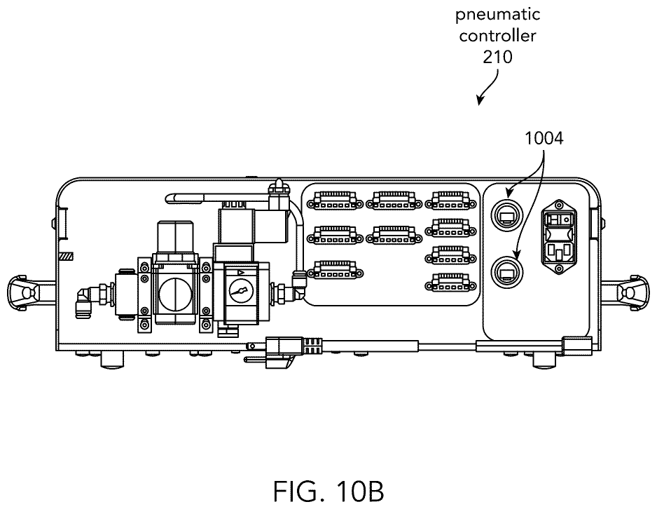

FIGS. 8A-14 depict various views of an example pneumatic controller 210. FIG. 8A depicts a perspective front view of the pneumatic controller 210, where a number of gas (e.g., air) ports (e.g., see FIGS. 10A, 1002) are depicted. Each gas (air) port 1002 may correspond to a specific pneumatic actuator via which a mechanical component may be moved, via a motion device being actuated. For example, the connection cable(s) 212 may be connected to the air port 1002, wherein the pneumatic controller is configured modulate the air within the cables to extend and/or retract a given cylinder. Any given pneumatic actuator may include any number of double-acting pneumatic actuators (such as four). For example, the pneumatic controller may include eight (which may be any number, such 1, 2, 3, 4, 5, 10, 15, 20, and so on) solenoid valve outputs total, which include four extend and four retract.

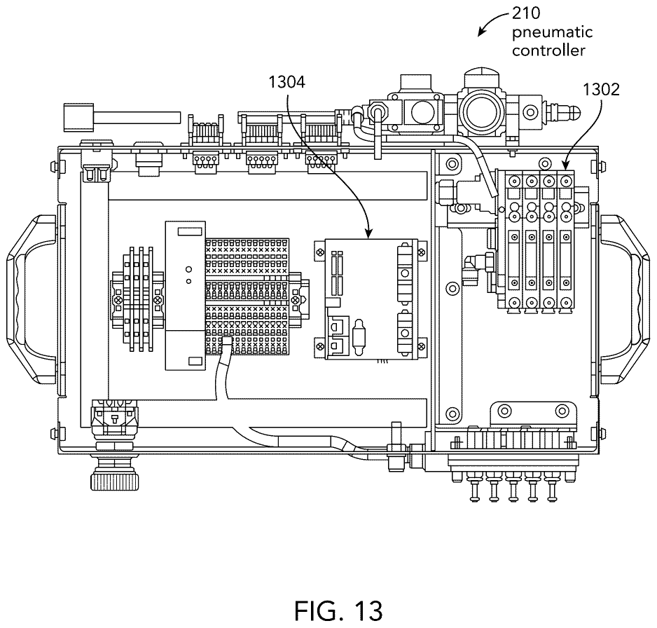

In some embodiments, the pneumatic controller 210 is connected to a pressurized gas (e.g., air) supply (e.g., any air supply with sufficient pressure, which may include a compressor). In some cases, solenoid valves (e.g., 1302 in FIG. 13) are opened or closed based on the commands (such as received from the software module and/or from a pneumatic controller processor 1304 in FIG. 13 [e.g., as described herein, and e.g., a computing controller for the pneumatic controller]) to feed that pressure (e.g., by allowing and/or preventing pressurized air) into the pneumatic actuators, at which point the pneumatic motion occurs.

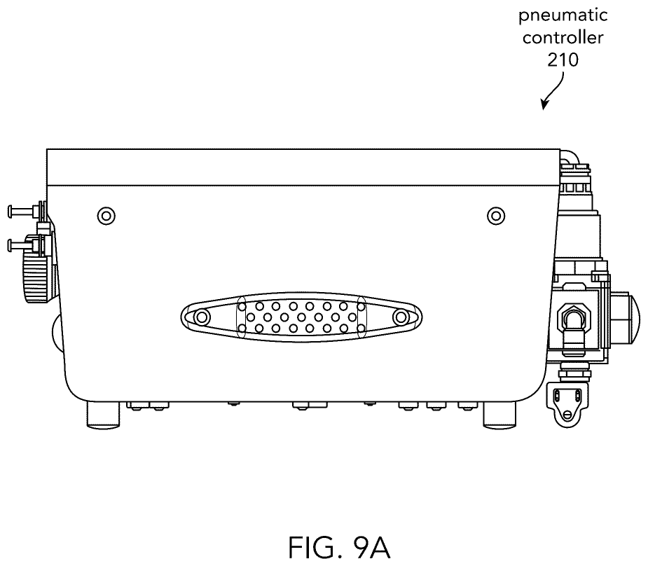

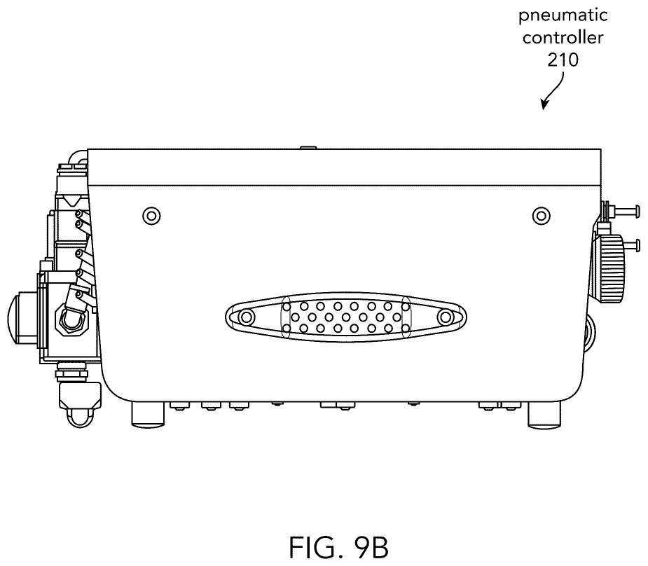

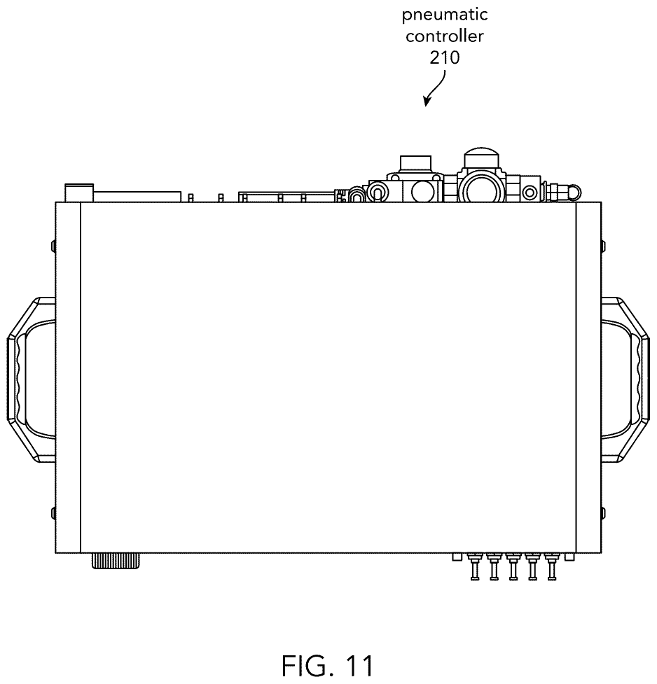

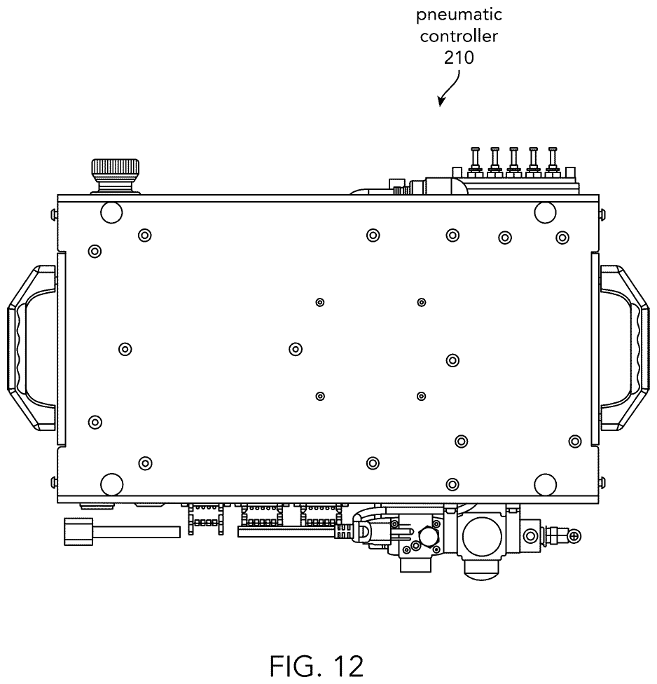

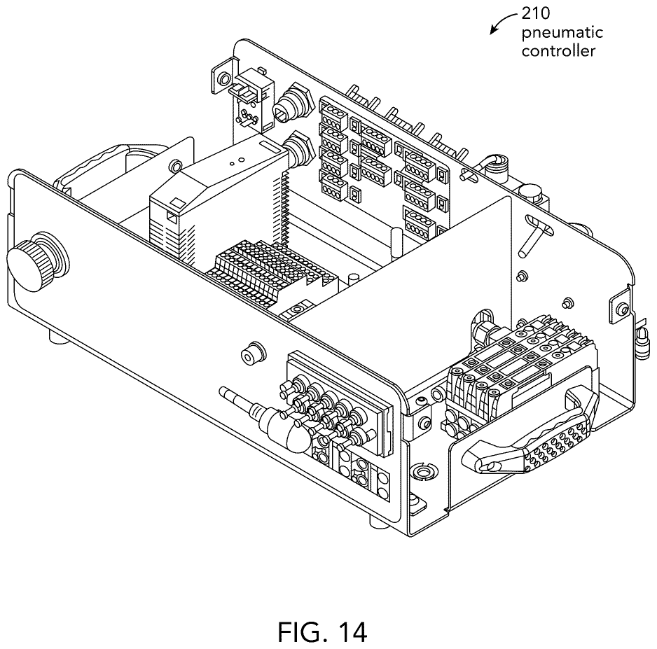

FIG. 8B depicts a perspective back view of the pneumatic controller 210, depicting one or more I/O ports 802. As described herein, each motion controller may be configured to transmit and receive data (e.g., from the software module, to other motion controllers [regardless of type]). In some cases, such data transfer occurs via an Ethernet wire. FIGS. 9A-9B depict a first side and a second side view of the pneumatic controller 210, respectively. FIGS. 10A-10B depict a front and back view of the pneumatic controller 210, respectively. FIG. 10B depicts an example of a pair of Ethernet wire ports 1004. FIGS. 11-12 depict a top view and a bottom view of the pneumatic controller 210, respectively. FIGS. 13-14 depict a top interior view, and a front perspective interior view of the pneumatic controller 210, respectively.

The pneumatics controller 210 may include one or more digital position sensor inputs (e.g., eight), one or more remote inputs (e.g., foot pedal, push button, etc.), one or more digital outputs (e.g., four, nine), one or more digital inputs (e.g., four, nine), one or more analog inputs and/or outputs (e.g., two), or any combination thereof. The remote input may be via a M12 port.

The pneumatics controller 210 may include sensor feedback inputs that enable for precise motion control.

In some embodiments, a bundle motion controller (which may be a motor and a pneumatics controller) may include any number of (e.g., four) motor axes and any number of (e.g., four) pneumatic actuators, up to seventeen digital inputs, eight analog inputs, eight digital outputs, two analog outputs, and/or eight pneumatic outputs, all of which may be simultaneously controlled by the software module (of any system described herein).

FIGS. 2A-2B depict an example of an automation environment (e.g., 216) having multiple motion controllers (e.g., 202, 210) each controlling one or more motion devices (e.g., 206, 208, 214). For any system described herein, any number of motion controllers may be used, where each motion controller may be configured to be communicatively coupled with the software module. Each motion controller may be configured to control movement of any number of motion devices. In some embodiments, each motion controller is coupled with each motion device via a corresponding physical port located on the motion controller. For example, with respect to FIG. 2B, the motor controller 202 included motor receptacle cable ports 205. Accordingly, motion controllers may be scaled (by adding any number of ports) so as to allow for any number of motion devices to be coupled thereto.

Each motion controller may be limited to a specific type, or may include multiple types. For example, a motion controller may only be a motor controller, only a pneumatic controller, and/or may be both a motor controller and a pneumatic controller (e.g., it may be able to control motion devices via motor control, and either the same motion devices or other motion devices via pneumatic control).

In some embodiments, some motion controllers may be integrated with a corresponding number of motion devices, such that the motion controller may already ascertain certain properties of each motion device (as described herein). For example, properties such as size, linear slide length, travel limits, etc., may be associated with each motion device configured to be coupled to the motion controller. As described herein, the motion controller may include, for example, one or more processors, in communication with the software module, to relay such information. In such cases, the software module may be integrated with the motion controller(s), and thereby be configured to automatically populate certain parameters relating to the motion controller(s) (e.g., motion devices, I/O devices, sensors, and/or number of ports associated with each controller). Alternatively or additionally, respective properties for the motion controller(s) may be manually provided to the software module.

As described herein, the software module may be in communication with one or more motion controllers. For example, the software module may be in communication with a plurality of motion controllers, such as 2, 3, 4, 5, 10, 15, 20, or more motion controllers. In some embodiments, the software module may be in communication with one or more of the motion controllers via a wireless connection (e.g., Bluetooth, WIFI, Cellular Data, etc.). Additionally or alternatively, the software module may be in communication with one or more of the motion controllers via a hardwire connection (e.g., via a cable connection). As described herein, the software module may be in communication with the motion controller(s) via an Ethernet cable. In some embodiments, the software module is configured to be in communication with a plurality of motion controllers via a daisy-chain linkage. For example, the software module and plurality of motion controllers may be communicatively coupled to one another via a hardwire daisy-chain, where the motion controllers are connected together in series. As such, a computing device (associated with the software module) may be connected to a first motion controller, wherein the first motion controller is also connected to a second motion controller, wherein the second motion controller is also connected to a third motion controller, and so on.

Each motion controller may include one or more Ethernet ports (as described herein) for connecting with a corresponding Ethernet cable. For example, the motion controller(s) may include RJ-45 “Data/PC” Ethernet ports. One Ethernet port may be used to connect with the computing device (e.g., that is operating the software module), while another Ethernet port may be used to daisy-chain an additional motion controller. The additional motion controller may use one Ethernet port to connect with the first motion controller, and a second Ethernet port may be used to daisy-chain to yet another motion controller.

When multiple motion controllers are connected, the hardwire (e.g., Ethernet) daisy-chain forms a distributed network, in which each motion controller may be configured to register its internet protocol (IP) address and/or motion device type (e.g., motor or pneumatic). The software module may be configured to communicate concurrently with all nodes (e.g., all motion controllers part of the daisy-chain), transmitting each command to the appropriate motion controller and aggregating feedback into one interface. This architecture allows for synchronized operation across several motion controllers with a single hard-wired connection to the computing device (e.g., that is used to provide and/or execute the software module).

The use of Ethernet cables may help to provide low-latency, high-integrity communication required for synchronized multi-axis motion and/or safety-critical commands (e.g., E-Stop, sensor triggers, etc.). Moreover, the use of an Ethernet link helps provide speed, reliability, and deterministic timing required for industrial motion control while maintaining a simple plug-and-play setup.

As described herein, the communication between the software module and the motion controller(s) may help provide real-time feedback and error reporting through a continuous, bidirectional hardwire (e.g., Ethernet) data stream between the motion controller(s) and the software module running on a connected computing device. For example, all runtime data, such as for example, cycle status, current operation, elapsed time, sensor states, and/or any detected fault conditions, are transmitted from the motion controller(s) back to the software module for immediate and automatic display (e.g., to the user), without any user programming. Accordingly, such hardwire connection(s) help provide a closed-loop communication that helps ensures the user interface (e.g., via the software module) always reflects the motion controller's live or substantially live state.

The software module may be configured to transmit the generated motion sequences over the Ethernet link to the controller(s). For example, the software module may be configured to provide instructions (e.g., commands) line by line. The motion controller(s) may be configured to parse and/or execute those applicable instructions locally, handling all real-time or substantially real-time motion control at the hardware level. As described herein, for multiple controllers, though the instructions may be provided to all the motion controllers, each motion controller may be configured to only execute the instructions associated for its respective devices.

Once a motion sequence begins (e.g., via the commands provided to the motion controller(s) by the software module), the motion controller(s) may also be configured to continuously stream status data (e.g., start time, current step, elapsed time, sensor states, errors, cycle count/sequence count, end time etc.) back to the software module over the same Ethernet channel(s) for real-time or substantially real-time display (e.g., through a visual interface, as described herein). The motion controller(s) may be able to stream live data packets at high frequency (e.g., tens to hundreds, to potentially thousands, of updates per second). As such, this feedback mechanism may help enable the operator (e.g., user) to monitor execution progress (e.g., of motion sequence(s)) in real time without opening or editing the underlying programming for the software module.

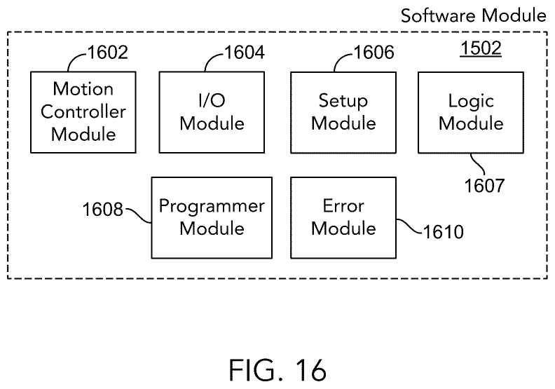

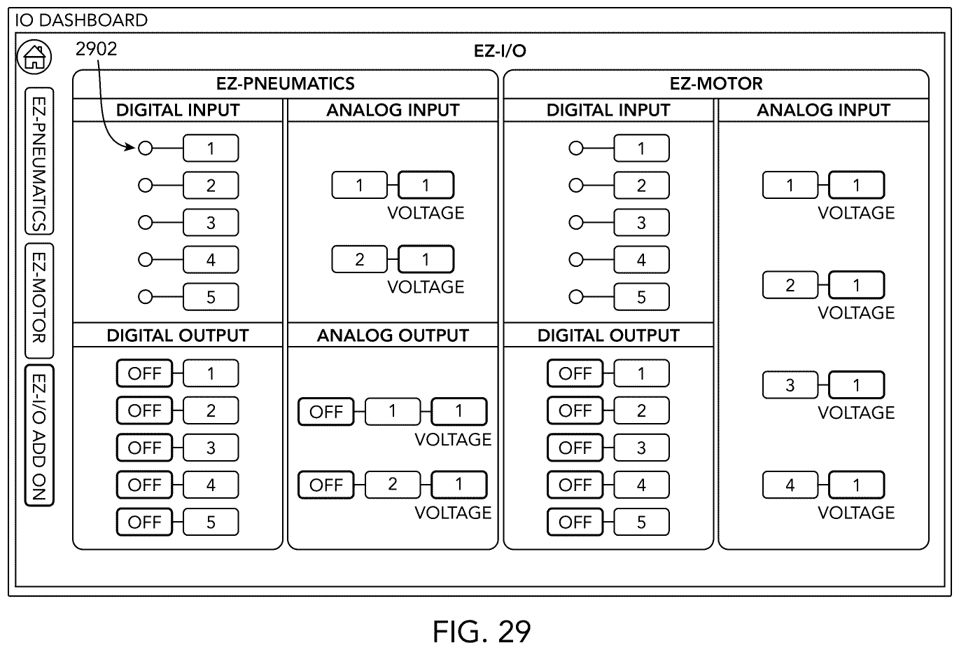

In some embodiments, all connected sensors, including for example digital and/or analog sensors, report their states back to a respective motion controller, which then relays them to the software module. As described herein, the software module may include an I/O module (e.g., 1604 in FIG. 16) configured to receive sensor and output states from the motion controller(s). In some cases, the I/O module is configured to display status identifiers for the sensors, including colors, font, boldness, graphical representations, or any combination thereof. In one example, the identifiers are visualized as red/green indicators, where, for example, digital inputs change from red to green when active, analog inputs display numeric values continuously, and/or digital outputs may be toggled manually, with the I/O module confirming state changes in real-time or substantially real-time. This visual feedback allows the user to verify sensor operation and diagnose hardware connectivity in real time. FIG. 29 depicts an example user interface depicting I/O devices and status indicators for respective motion controllers. The digital input may include indicators (2902) that may change between colors (e.g., red and green, as described herein).

The motion controller(s) may also be configured to automatically identify error conditions, and relay such error conditions to the software module in real-time. The motion controller(s) executes checks for error conditions automatically. Example types of error are described further herein. The software module may include an error module (1610, see FIG. 16) configured to receive an error fault (e.g., from the motion controller(s)), display to the user the error (in real-time or substantially real-time), stop a motion sequence, and/or freeze visual status indicators.

### Software Module

As described herein, for any system, the software module may be communicatively coupled with one or more motion controllers, so as to provide instructions for performing one or more automation sequences (e.g., motion sequences, sensor sequences, etc.). For example, the software module may be configured to generate the one or more motion sequences based on input received from a user and/or based on properties associated with the motion controller(s).

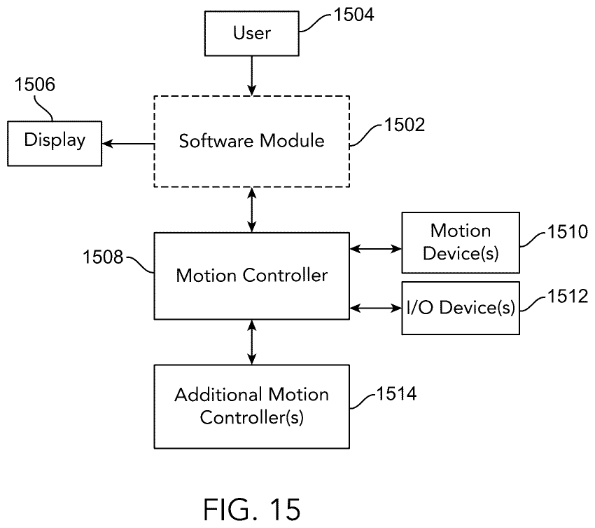

FIG. 15 depicts an example illustration of a communicative coupling between components of a system, according to an embodiment. The software module 1502 may be provided with, and/or, executed using, one or more processors. For example, the processor(s) may include one or more memories for storing instructions, that when executed, allow the system to perform operations that include actuating motion sequences by one or motion devices. The processors may be included with one or more computing devices. For example, the computing device may be a personal computer, laptop, tablet, smart device, and/or any other device having computing power. The computing device(s) may be disposed within a vicinity of the user 1504 and/or motion controller(s). In some cases, one or more of the computing devices may be disposed remotely (e.g., cloud computing, via wireless communication, via Bluetooth, etc.).

The software module 1502 may be configured to receive input from the user 1504 via a user interface. This may include any known interface, including via peripheral devices such as a mouse and/or keyboard, and/or other forms including for example, a touch screen, haptic feedback, voice input (via a microphone or other sound detector), etc.

The software module 1502 may further provide an output via a display 1506 (which may be in communication with the one or more processors), which may provide information relating to generating one or more motion sequences, displaying motion controller(s) status', motion sequence updates, error messages, and/or real-time or substantially real-time data (as further described herein). The display may include outputting a visual interface (e.g., a GUI), as described herein. The display may be via any known display, including a display screen, a projection, etc.

The software module 1502 may be in communication with a motion controller 1508 (e.g., motor controller 202, pneumatic controller 210, or both). As described herein, the software module 1502 may be in communication with the motion controller 1508 via a hardwire (e.g., Ethernet) connection. Other embodiments may include a wireless communication.

The software module 1502 and the motion controller 1508 may be configured for bi-directional communication. The motion controller 1508 may in turn be in communication with one or more motion devices 1510 (e.g., see FIGS. 2A-2B, such as 206, 208, 214) and/or one or more I/O devices 1512 (e.g., see FIGS. 3A-14). The motion controller 1508 may provide data (e.g., instructions, commands) to the motion device(s) 1510, and/or may provide actuation means, and/or the motion controller 1508 may receive data (e.g., feedback data) from the motion device(s) 1510. The motion controller 1508 may also provide data and/or receive data from the I/O devices (e.g., digital input/output, analog input/output-which may include sensors). The I/O devices, which may include sensors, may in some cases, but not always, also be configured with bi-directional data transfer with one or more of the motion devices 1510.

The software module 1502 may further be in communication with one or more additional motion controllers 1514. As described herein, such connection may be via a daisy-chain hardwire (e.g., Ethernet) link.

FIG. 16 depicts an example illustration of the software module 1502 and various modules therein. The software module 1502 may include a motion controller module 1602, an I/O module 1604, a setup module 1606, a logic module 1607, a programmer module 1608, and/or an error module 1610. Although various modules are described herein, it is understood that the modules may be provided for reference, and that the software module may not include some of these modules, and/or may include additional modules, and further that the modules represent the capabilities and actions performed by the software module as a whole.

The motion controller module 1602 may be configured to be in communication with each motion controller included with the system (e.g., as coupled together, such as through the daisy-chain link). The motion controller module 1602 (i.e., the software module) may be configured to receive information relating to each motion controller, including for example, type of motion controller (motor, pneumatic), number of devices coupled thereto (e.g., number of axes for motor controller, number of cylinders for pneumatic), number of I/O devices coupled thereto, number of ports available for motion device and/or I/O device connections, and/or other specific information (e.g., encoder information, etc.). In some cases, the information is automatically populated in the motion controller module 1602. For example, the software module may automatically discover and register all connected motion controllers, identifying each as a motor controller or a pneumatic controller. As described herein, a given motion controller may comprise one or more processors, configured to relay information and properties of the motion controller to the software module. Such automatic discovering and registering by the software module may, in some cases, be due to the motion controller(s) being pre-integrated with the software module. As such, the motion controller module 1602 may already be ascertained as to several of the information for a given motion controller module.

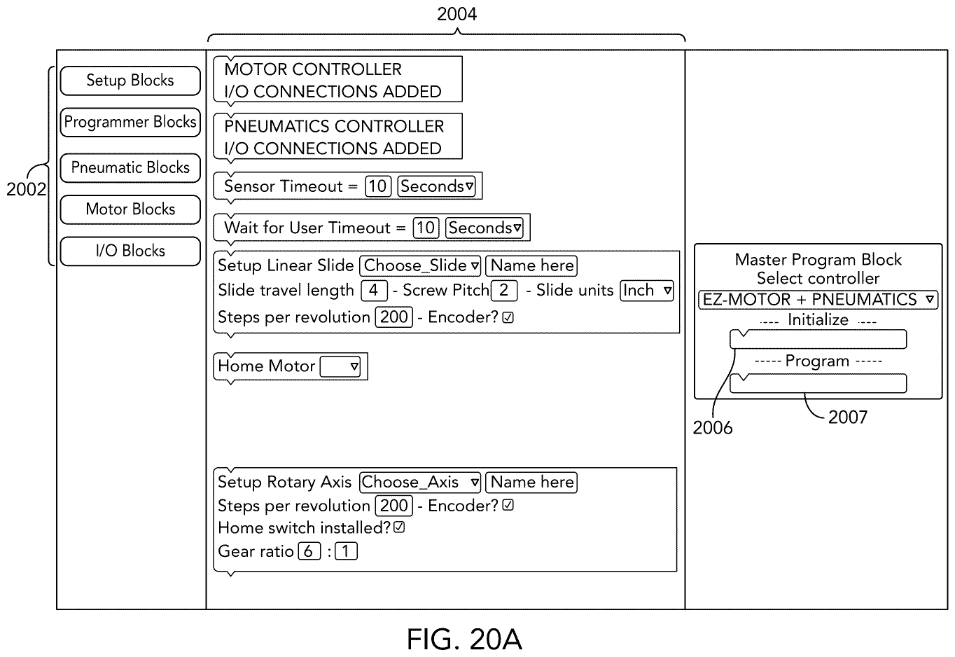

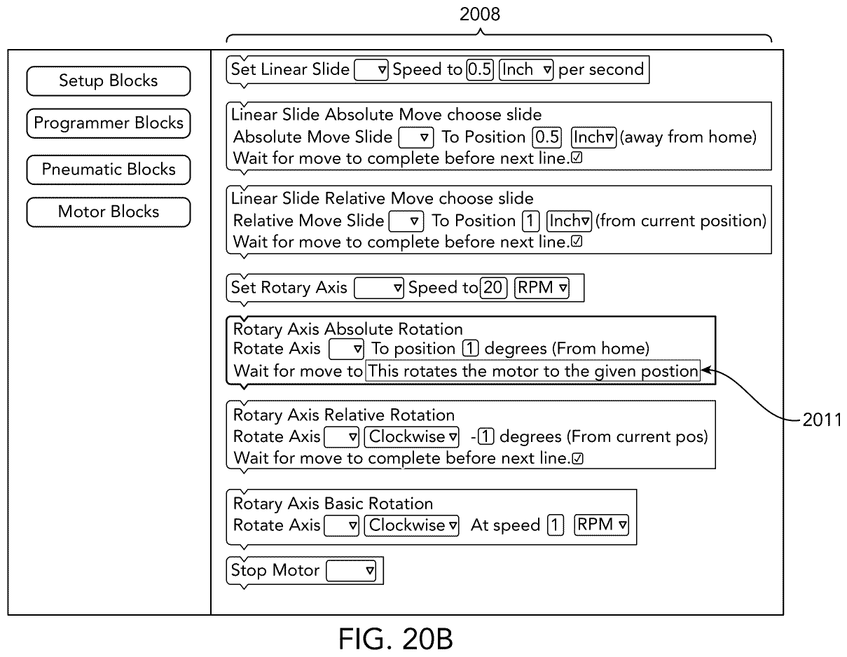

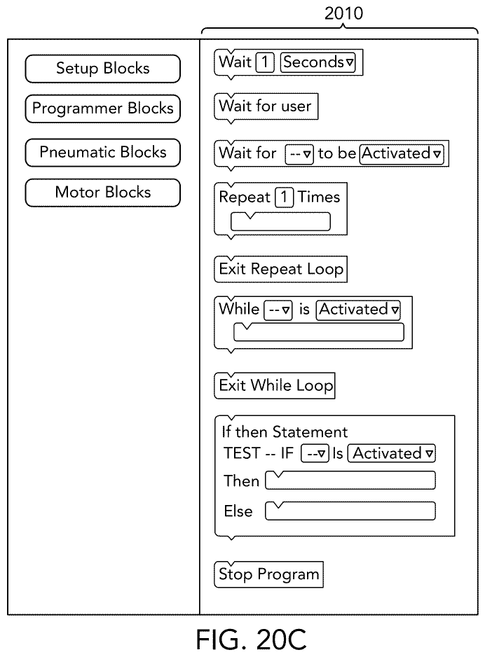

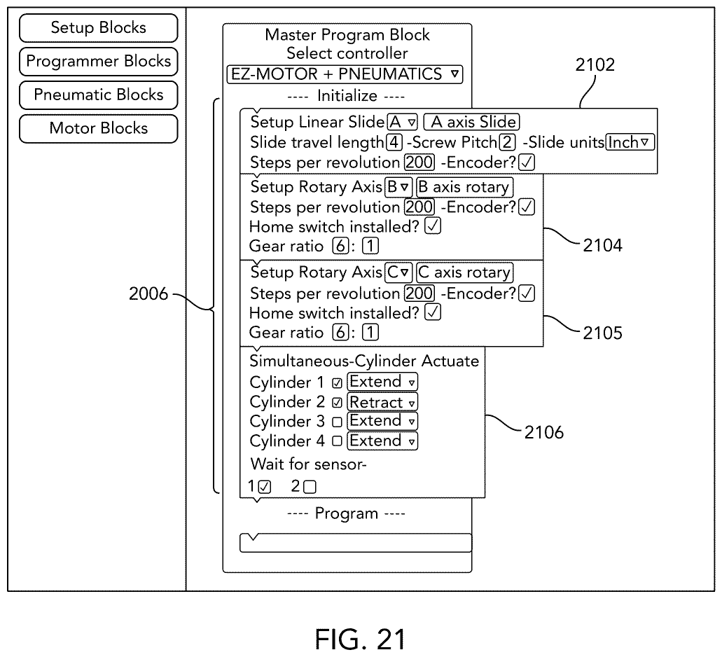

Alternatively or additionally, at least some information (as described herein) may however need to be manually inputted by the user. This may include type of motion controller (motor, pneumatic), number of devices coupled thereto (e.g., number of axes for motor controller, number of cylinders for pneumatic), number of I/O devices coupled thereto, number of ports available for motion device and/or I/O device connections, other specific information (e.g., encoder information, etc.), and/or what type of motion is for a given axis (e.g., for a motor controller), such as linear motion or rotary action. The motion controller module 1602 may obtain some of this information during an initializing stage (e.g., when some of the devices, properties, and/or parameters are being registered with the software module, either manually or automatically)—see FIG. 21 for example. Accordingly, for a given motion controller, the motion controller module 1602 may be used to identify the parameters associated and/or available for a given function block that need to be specified, as part of a generated motion sequence, as described herein. For example, if the motion controller includes a linear slide as one motor axis, corresponding parameters relating to a linear movement will be identified when defining a function block for linear motion. See FIGS. 20B, 2008 for example, as relating to the motion controller module for a motor controller.

Examples of motion controller inputs for motion configuration may include number of axes, axis type (e.g., linear or rotary, depending on whether it drives a linear slide or a rotary motor) and/or mode, and/or speed and acceleration. For the number of axes, any number of motion axes may be defined for motors (e.g., four independent motion axes (A-D)), while any number of pneumatic actuators may be defined (e.g., cylinders 1-4). Each axis or actuator may be independently configured and addressed within a sequence (e.g., as part of a function block). For speed and acceleration, each motion function block may be configured to receive a user-defined speed value (in user-selected units such as in/sec, mm/sec, RPM, or deg/sec). Acceleration may be handled automatically by the respective controller for smooth motion.

Examples of motion controller inputs for positional inputs may include absolute and relative position (e.g., numerical target positions as absolute distances from home or relative displacements from the current position), and/or direction of motion (e.g., for rotary axes, direction (clockwise or counter-clockwise)).

Accordingly, such inputs may be provided using appropriate graphically assembled blocks (e.g., see FIG. 20A-25B), without any need for programming or coding.

The I/O module 1604 may be configured to be in communication with each I/O device coupled to a motion controller. Such I/O devices may include, for example, sensors (any type, such as flow, pressure, location, temperature, etc.), load cells, pressure transducers, and/or limit switches. The I/O module 1604 may be configured to obtain information relating to an I/O device, such as sensor type, for example. Accordingly, for a I/O device, the I/O module 1604 may be used to identify the parameters associated (with the I/O device) for a given function block that need to be specified, as part of a generated motion sequence, as described herein. The motion controller module 1602 may also be used to communicate and obtain the information relating to the sensor(s) (instead of the I/O module 1604). In some cases, the I/O module 1604 may be configured to automatically identify the number of I/O ports available for a given controller, such that a specific I/O port may specified as carrying out a specific action (e.g., a sensor timeout, feedback, etc.).

Examples of I/O devices and sensor integration include digital inputs (which may include digital PNP inputs), any number (such as 9) on the pneumatic controller and any number (such as 5) on the motor controller, (which may be used for position sensors, limit switches, or external triggers), analog inputs (e.g., any number (such as 4) of analog inputs (motor controller) and any number (such as 2) of analog inputs (pneumatics controller)) for sensors providing continuous feedback (e.g., pressure, load, position), digital outputs (e.g., used to activate external devices, such as glue valves, lights, solenoids, etc.), analog outputs (e.g., pneumatics, for controlling proportional valves and/or analog-driven peripherals), user-defined sensor conditions (e.g., function blocks allow logic such as “Wait for Sensor Activated/Deactivated” or “If Sensor X is Active Then . . . ”), and/or remote user inputs (e.g., foot pedals or push buttons connected via M12 port can trigger “Wait for User” or resume program execution).

In some embodiments, the I/O module 1604 and/or the logic module 1607 may use one or more I/O parameters to trigger various conditions and/or actions in the hardware equipment.

The setup module 1606 may correspond to specific parameters associated with a function block that may provide limits and/or predefined inputs for certain parameters. Examples of parameters that may be specified as part of the setup module include, for example, axis ID (e.g., for a motor controller), alias, slide length, screw pitch, steps/rev, encoder yes/no, and/or units. For example, the setup block may allow a user to specify a motor's steps per revolution, and/or whether microstepping or encoder feedback is used. These parameters may then help establish motion resolution (e.g., 0.028° per microstep for 200-step steppers at 64 microsteps). Another example for setup module includes conditions for a linear slide, where a specific motor axis is defined with a set stroke (e.g., 200 mm) and encoder feedback, such that the function block, when being defined, will automatically enforce such position limit on a respective parameter (either while being defined, and/or at a verification stage, as described herein). For example, the software module may automatically calculate and enforces motion limits based on the entered slide length and pitch, preventing over-travel. Another example relates to homing configuration, where input fields define whether a home switch is present, and the behavior during homing (e.g., direction, switch type, encoder feedback).

Yet another example relates to gear ratio, lead screw pitch, and/or slide length, where inputs for mechanical transmission characteristics may allow automatic conversion from rotational units (steps or degrees) to linear units (mm, inches, etc.). The parameters may also enable for direct angular control to be maintained.

FIG. 20A, at 2004 depicts, and FIG. 21 at the initialize block 2006, depict an example of parameters and conditions specified for the setup module 1606.

In some cases, due to the allowed interchangeably (e.g., via the software module) between linear movement and rotary movement for a given motor axis, no hardware configuration is required, only a change in the setup module parameters. For example, any of the motor outputs (e.g., axes) for a given motor controller may be reassigned between linear and rotary motion at any time by editing the setup parameters in the setup module 1606. As such, a linear slide could be replaced with a rotary motor (or vice versa) using the same physical channel (on the respective motor controller). The system is configured to automatically recalculate scaling factors (e.g., converting step counts to inches or degrees) based on the setup inputs. In some cases, safety limits (max travel, home position) remain enforced according to whichever mode is active. Thus, the hardware outputs are fully interchangeable; the linear-vs-rotary distinction exists only in the software module. Furthermore, such interchangeability may be facilitated via graphically assembling and/or defining parameters for the associated motion controllers (and associated devices).

In another example, the setup module 1606 may be configured to set up analog I/O parameters to define voltage as it relates to device output values (e.g., force, temperature, pressure, etc.).

The logic module 1607 may be configured to receive specific logic actions, that may be a part of a function block. This may include, for example, an if-then action, a repeat action, a wait action, and/or a wait for user action. Such logic actions may be user specified, and specific to any one or more motion controllers, optionally even more specific to a given axis or cylinder for a controller.

FIG. 20C, at 2010 provides an example of parameters and conditions that may be specified and/or available via the logic module 1607.

In some cases, the logic module 1607 and/or the I/O module 1604 includes a sensor timeout duration, which allows for a custom timeout value for sensor timeout to be specified (in some cases a default value is applied, such as 10 seconds).

In some embodiments, the software module enters an initialization phase where, upon connecting to all the controllers, discovers and registers said controllers, such that certain inputs for certain motion controllers may be specified. This may include inputs for initial actuator state (extend/retract), homing routine execution, and/or enabling/disabling axes prior to the first cycle.

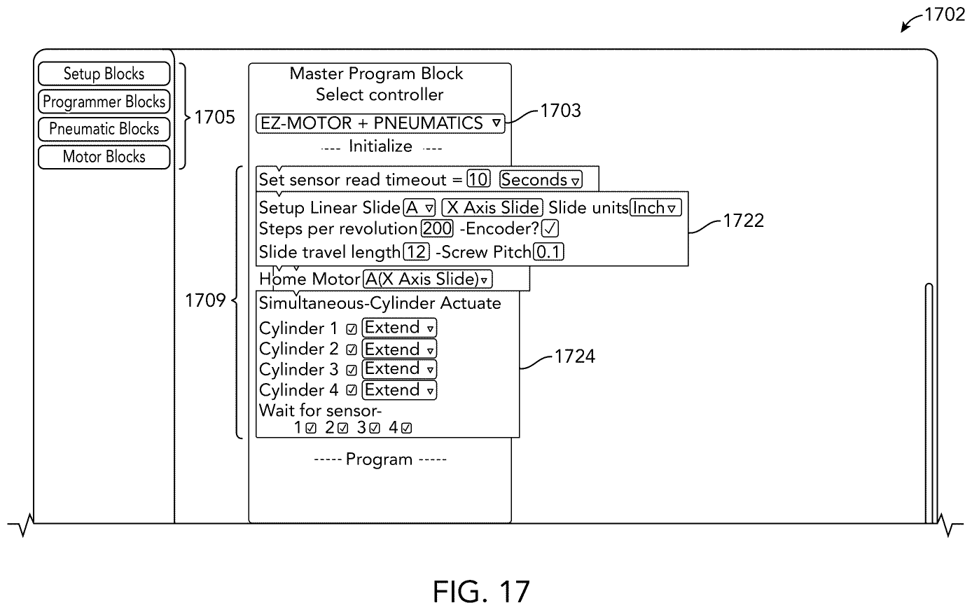

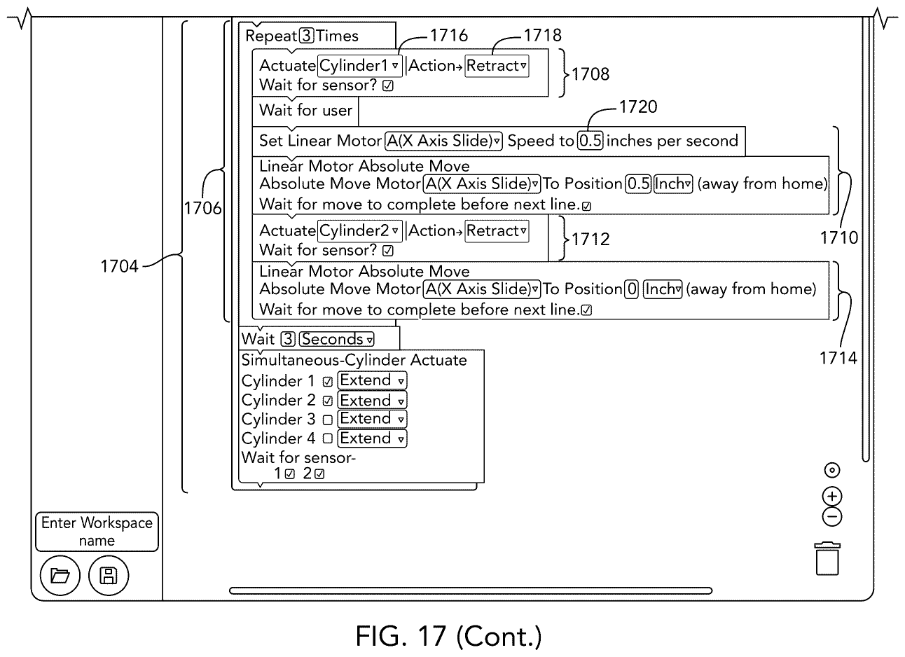

The programmer module 1608 provides a visual interface (e.g., GUI, user interface) for generating the motion sequence(s), which may include the initialize stage for setup of parameters and/or conditions. As described herein, the motion sequences may be generated by modularly adding function blocks, each of which may graphically defined based on available parameters for a given action. Accordingly, the programmer module 1608 may be visually displayed via the display (1506, for example), which may be communicatively coupled with the one or more processors. FIG. 17 depicts an example of the visual interface 1702 via the programmer module 1602, wherein multiple function blocks (e.g., 1706, 1708, 1710, 1712, 1714) have been defined, generating a motion sequence 1704. As described herein, the programmer module 1608 may allow for each parameter of a function block to be added modularly, and/or graphically via the visual interface 1702. For example, the function block parameters, and the function blocks themselves, may be added using a drag-and-drop development environment. As such, users may generate motion sequences visually, which the system may then translate into executable code (as opposed to hard coding the motion sequences, which may be highly cumbersome).

The programmer module 1608 is further configured to provide a scalable canvas for building hierarchical sequences. For example, programmer module 1608 may provide an interface (e.g., visual interface) that can be divided into various sections, such as for example, an initialize block 1709 (e.g., for defining initial system settings, including home positions), and/or a sequence generating section 1704 (e.g., for specifying sequential or conditional motion instructions). Moreover, programmer module 1608 may allow the various modules and corresponding parameters and/or conditions to be categorized via master blocks 1705.

The error module 1610 may be configured to detect and/or receive error conditions occurring before, during, and/or after a motion sequence is executed by the system. In some cases, the error module 1610 receives the error conditions from a respective motion controller, which may have initially identified the error condition. The error module 1610 may be configured to automatically seek to mitigate the error. For example, where the error condition is a sensor timeout (e.g., a sensor fails to activate/deactivate within the configured time, which may be a default of 10 seconds or as set in an I/O block as a sensor timeout), the error module 1610 and/or motion controller (optionally on its own) may stop the motion sequence. The error module 1610 may be configured to display an error message via the display.

Another example of an error condition includes a wait-for-user timeout, where a user input was not received within a timeout limit, such that the execution of the motion sequence stops with a timeout notification presented.

Yet another example of an error condition includes an out-of-range motion command, where a move command (e.g., instructions) exceeds a defined slide length or rotary limit, such that the motion controller blocks the command, and issues a range-error message (as displayed via the error module 1610).

Yet another example of an error condition includes an emergency stop (E-stop), where a hardware E-stop is activated (e.g., pressed) on a motion controller, thereby resulting in the given motion controller to de-energize outputs, stop motion, and/or sends an E-stop signal to the software module (e.g., error module 1610). In some embodiments, the error module provides a software Stop that halts sequence execution without de-energizing actuators. Hardware emergency-stop buttons on the controllers perform the safety-rated de-energization (motors vs. pneumatics respectively).

Yet another example of an error condition includes a communication loss, where a communication between the software module and any one motion controller is lost (e.g., Ethernet link interrupted), such that the motion sequence immediately terminates, and requires the user to reconnect the communication before initiating the motion sequence again.

In all such error conditions, the error module 1610 may be configured to, in real-time or substantially real-time, display an error message identifying the cause (e.g., a specific sensor timeout, or exceeded slide travel limit), stops execution of the motion sequence (thereby preventing further movement until the error condition is cleared), freezes visual status indicators (e.g., sensor dots, cycle count, “Current Process” field), signaling where the error occurred, and/or require the user to correct the issue (e.g., reconnect sensor, clear E-Stop, adjust setup block) and re-initialize the sequence. Accordingly, the error module 1610 may help ensure deterministic, safe shutdown behavior.

### Generating Motion Sequences

As described for any system herein, the software module may be configured to generate one or more motion sequences for a motion device, for which instructions relating to the motion sequence(s) may be relayed to a specific motion controller so as to actuate said motion device according to the motion sequence(s). The software module may be configured to generate the motion sequence(s) by defining one or more function blocks. Each function block may correspond to a specific action to be carried out by the motion device and/or an I/O device via instructions received and/or actuation initiated by a respective motion controller.

Such specific action may not necessarily correspond to actual movement by the motion device, but may include other functions. This may include, for example, a wait action, an in-then action, and/or a sensor trigger (e.g., limit switch).

Examples of types of action corresponding to a function block include move (e.g., linear slide absolute and/or relative move or rotary axis absolute and/or relative rotation, for motor controllers), actuate (e.g., actuate or simultaneous-cylinder actuate, for pneumatic controllers), wait, if-then, sense, loop, stop program, and/or logic conditions. For example, an if-then function block may define steps to determine if a condition has been met, before carrying out the next part of a motion sequence.

Each function block may be defined by one or more parameters, wherein the number of parameters available depends on the action being performed. For example, for a specific type of motion controller, such as a motor controller, there may be a corresponding number and type of parameters available when defining a function block associated with the motor controller. Such available parameters may be provided, specified, and in some cases pre-inputted, and may be retrieved from the motion controller module 1602, the I/O module 1604, and/or the setup module 1606 for the specific motor controller (as described herein). Examples of parameters that may be associated with a given motor controller include axis (e.g., A-D if there are four available), motion type (linear or rotary), target position (absolute), units (mm, inch, degree, revolution), speed, acceleration (automatic but user-overridable), wait for completion (yes/no), direction of motion (for rotary), rotation speed, rotation amount, rotation units, timeout duration, conditional trigger (e.g., If Sensor Active), alias or name of axis (user-assigned), encoder enable/disable, gear ratio or pitch (if applicable), steps per revolution (motor configuration), home switch configuration, homing method (sensor or manual), number of repetitions (if nested in repeat block), delay after move (if “Wait” block follows), output activation upon completion (optional digital output), and/or sensor interlock condition. In some cases, a single motion command for a motor controller (e.g., single motion function block) may include up to 20 distinct input parameters, either directly in the function block, or via the associated respective motion controller module, I/O module, setup module, and/or logic module.

Similarly, for a given pneumatic controller, there may be a corresponding number and type of parameters associated with the pneumatic controller. Such available parameters may be provided, specified, and in some cases pre-inputted, and may be retrieved from the motion controller module 1602, the I/O module 1604, and/or the setup module 1606 for the specific pneumatic controller (as described herein). Examples of parameters that may be associated with a given pneumatic controller include cylinder selection (e.g., 1-4 if there are four available), cylinder ID, action (extend or retract), wait for sensor (yes/no), associated sensor number (1-8), timeout duration, wait time (if no sensor used), pressure condition (if monitored via analog input), repetition count (if within loop), sequence delay after actuation, conditional logic (e.g., If sensor active then actuate), simultaneous actuator selection (multi-check option), digital output activation upon completion, manual override option, and/or error handling condition (on timeout). In some cases, a single pneumatic action (e.g., single pneumatic function block) may include up to 14 distinct input parameters.

Each function block associated with a logic and/or control action may also include a certain number and type of parameters available. Such available parameters may be provided, specified, and in some cases pre-inputted, and may be retrieved from the motion controller module 1602, the I/O module 1604, the setup module 1606, and/or the logic module 1607 for the specific actions (as described herein).

Examples of parameters that may be associated with a given if-then action include sensor or digital input number, sensor state (activated/deactivated), comparison operator (equals, not equals, etc.), and/or nested “Then” action (another block or set of blocks), nested “Else” action (optional), and/or “Stop Program” action (which may allow to control flow of motion sequence based on input signals and/or internal status).

Examples of parameters that may be associated with a given repeat action include number of iterations, nested operation(s) (e.g., actions) to repeat, and/or optional early-exit condition (e.g., via “Exit Repeat Loop”). Such repeat action (e.g., repeat function blocks) may allow to define loop counts (e.g., integer values) for cyclical testing and/or endurance motion.

Examples of parameters that may be associated with a given wait action include duration (numeric), and/or units (seconds, minutes, hours, days).

Examples of parameters that may be associated with a given wait for user action include input device type (software button, remote trigger, etc.), timeout duration, and/or restart behavior (resume or terminate).

Examples of parameters that may be associated with a set output action include output number, and/or on/off state.

As described herein, for any input parameter for a given function block, such parameters may be received by the software module via a visual interface, such as dropdown menus, checkboxes, text fields, etc., as opposed to having to enter programming code. For example, in traditional coded motion systems, input parameters are hard-coded variables or require numerical entry in registers. By contrast, systems and methods described herein facilitate a modular, self-populating interface, where adding an action (e.g., function block) automatically associates the corresponding input fields. The system is further configured to enforce correct parameter dependencies (e.g., available axis IDs, valid range limits) and creates a real-time binding between the graphical inputs and the physical I/O configuration. For example, if axes B and C for a motor controller are defined as being rotary (e.g., during the initialize stage and/or via the setup module), any rotary based function blocks added to the motion sequence will restrict the axes available to be selected to B and C in real-time.

For any function block, the number of inputs that can be specified may be variable and action-dependent. In some cases, the number of inputs may range from 5 to more than 20 distinct user-definable inputs per function block, depending on the type of motion being controlled (motor, pneumatic, or mixed).

In some cases, a function block may be added and nested within another function block. For example, a linear movement of a motion device may include as part of the motion sequence a logic and/or control action (e.g., an if-then action). See FIG. 17 for example, where the repeat function block 1706 includes pneumatic 1708, 1712 and linear function blocks 1710, 1714 nested within (e.g., within the repeat function block 1706). In some cases, there can be a plurality of function blocks nested within a function block, and there can also be function blocks nested within function blocks that are also nested within other function blocks. Accordingly, depending on nesting depth, a single logic operation can represent dozens of input values across multiple block layers.

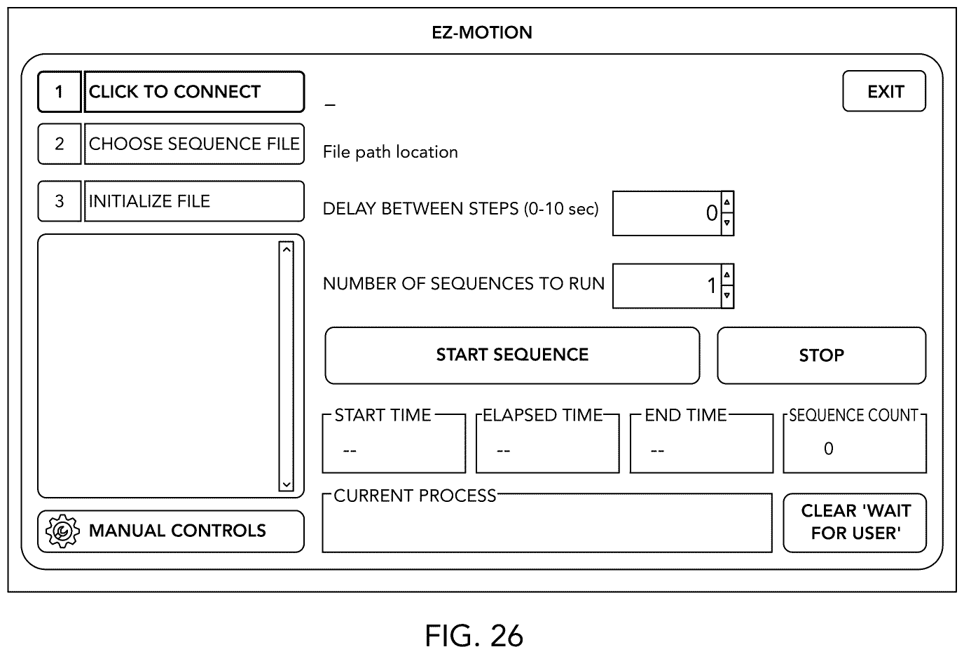

In some cases, the software module is configured to receive system wide inputs, such as number of motion sequences to run (e.g., 1 to 1 billion, such as 1 to 10 million), number of times to repeat a motion sequence (e.g., 1 to 1 billion), and/or delay between steps for a given function block (e.g., 0 to 100 seconds, such as 0 to 10 seconds). See FIG. 26 as an example of a user interface for receiving such system wide inputs. In some embodiments, such system inputs at the software module may be modified in real-time, without a need to modify the motion sequences.

Other system-wide inputs may include connection inputs (controller IP address and connection verification), cycle metrics inputs (monitoring and/or logging start time, elapsed time, end time, and/or current process step as real-time inputs displayed on the software module), and/or safety inputs (E-Stop conditions from hardware; “Stop” button within software module for software-level halts).

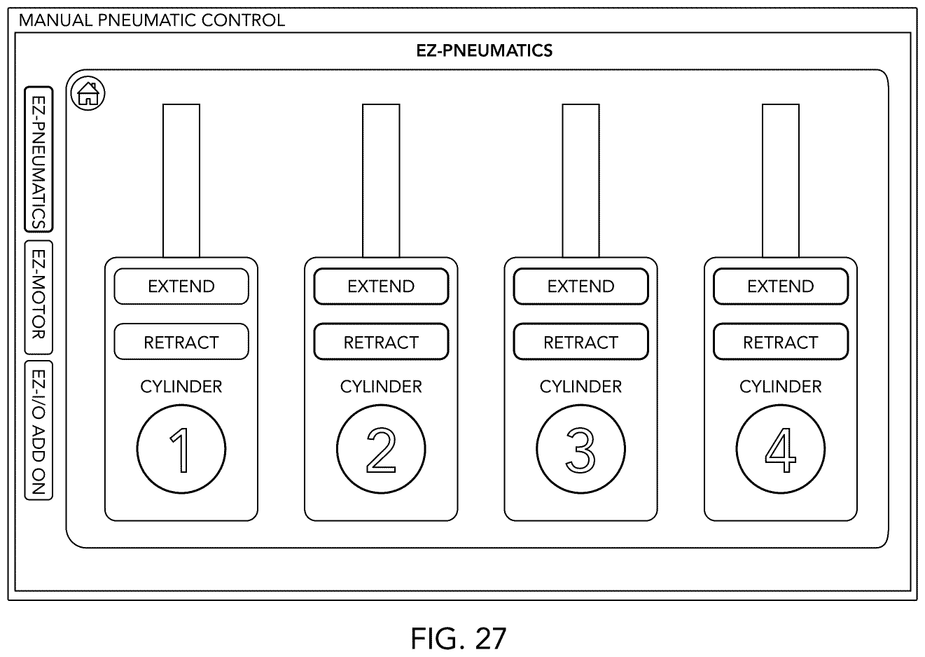

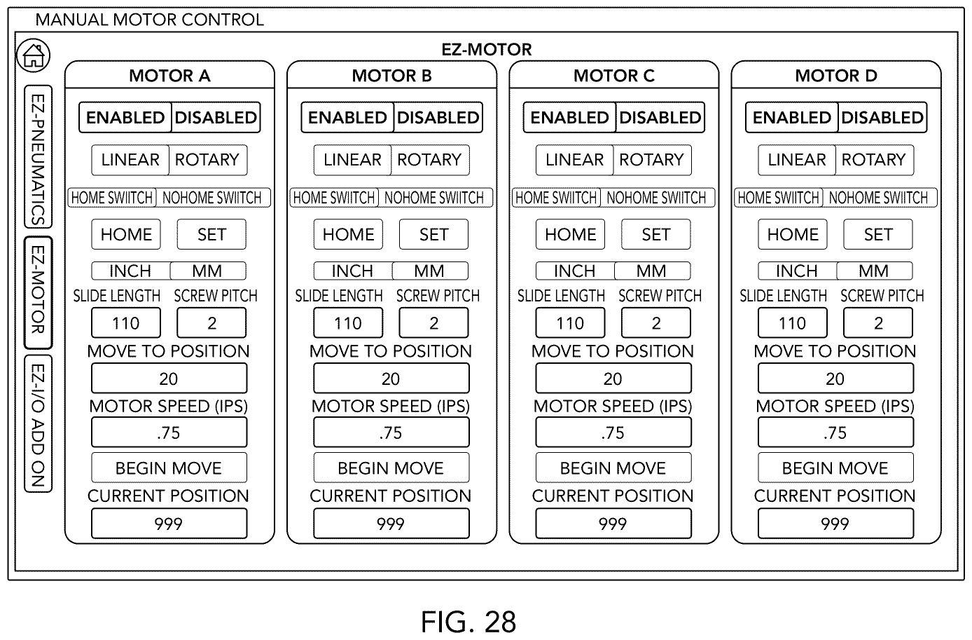

In some cases, the software module is configured to manually override certain inputs, such as target position, speed, slide length, screw pitch, and/or gear ratio for direct motion control. FIGS. 27-28 provide example user interfaces for such manual modes, where FIG. 27 is for a pneumatic controller, and FIG. 28 is for a motor controller.

As described herein, the software module 1502, via for example the programmer module 1608 (as described herein), provides a visual interface for a user to generate a motion sequence by defining one or more function blocks. The function blocks may be defined according to a hierarchical arrangement, which is facilitated by the visual interface that enables not only such arrangement of function blocks, but also enables the actual defining and assembly of each function block to be through a modular configuration. In other words, each function block may be added to a motion sequence through a graphical representation. For example, the programmer module 1608 may facilitate a drag-and-drop type environment for the function blocks to be added to a given motion sequence. The programmer module 1608 may further allow for the function blocks to be defined while arranged in the hierarchical arrangement, with the programmer module 1608 configured to facilitate automatic identification of the required parameters, and receipt of user input for such parameters. For example, such parameters may be received via interactive dropdown menus, text fields, and/or checkboxes within each function block. In some cases, where the setup module 1606 includes parameters such as limits (e.g., a distance for linear slide), such limits may be automatically enforced by the software module when receiving input. For example, if the software module receives an input to move a motion device a distance that exceeds the travel length of the linear slide, such distance value may be automatically limited to the max distance (e.g., within the function block), and/or the input may not be entered. Alternatively or additionally, such exceedance of the slide travel length may be flagged at the verification stage (as described herein).

Accordingly, each function block is a self-contained command template with user-selectable input slots and/or automatically inputted information that was specified (e.g., via the setup module). Thus, the software module provides a no-code visual programming tool for generating motion sequences and conditions. For example, the user generates motion sequences by “adding” inputs by dragging the desired block type into the workspace (e.g., initialize block 1709 and/or sequence generating block of the motion sequence 1704) and filling in its input parameters using the GUI elements. These visual input fields receiving input parameters may correspond to parameters that the system uses to control motion, timing, and/or logic flow.

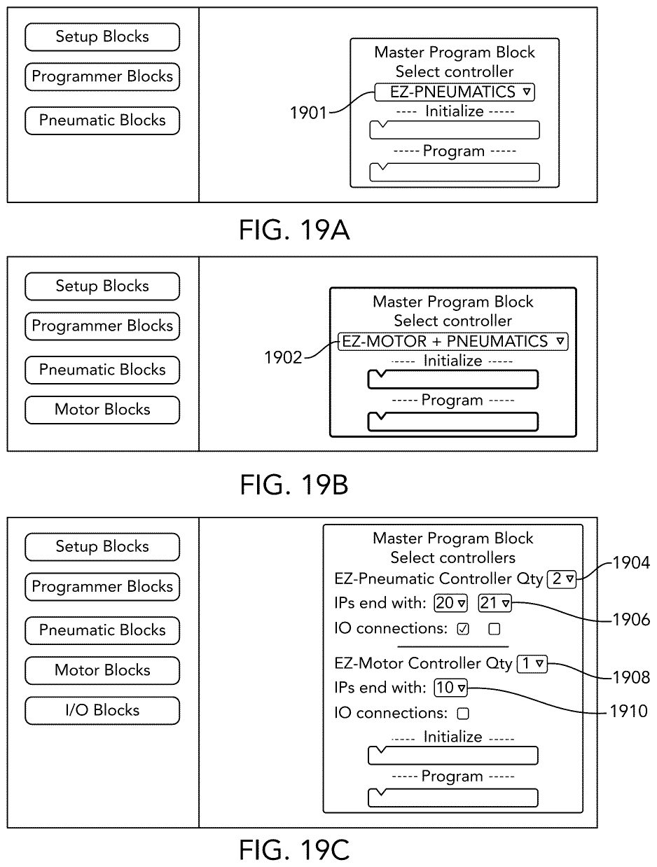

FIG. 17 depicts an example visual interface 1702 of a software module 1502 (e.g., via a programmer module 1608) depicting an example motion sequence 1704. The motion sequence is specified for a bundle motion controller 1703 including a motor controller and a pneumatic controller. As such, the available motion devices and actions, including a linear slide 1722 and cylinders 1-4 1724, may be automatically populated in the dropdown menus of the respective function blocks (e.g., when added to the sequence generating block of the motion sequence 1704). As described herein, such available motion devices and parameters may be automatically obtained via communicatively coupling the software module with the motion controller(s), and/or may manually inputted and stored (e.g., setup module, motion controller module). For example, as depicted, an initializing block 1709 may be initiated, allowing the software module to automatically discover and register all connected motion controllers. Here, the motor controller and the pneumatic controller may have been discoverable. As such, all associated parameters, I/O devices, and/or ports for devices and/or I/O devices may become automatically available to be selected when defining each function block. In some embodiments, where there are multiple controllers for each type (e.g., multiple motor controllers, multiple pneumatic controllers), the software module may again automatically discover and register all connected controllers, and make available all associated motion devices (e.g., axes, cylinders), all parameters, all I/O devices, and/or all ports for devices and/or I/O devices to be included with a respective function block (as pertaining to a master block 1705, as described herein). In some cases, the desired controllers for a motion sequence may be specified via identifiers, such as IP address for the desired controller(s) (see FIG. 19C for example). The software module may therefore provide a single, consolidated software interface that facilitates all motion hardware in the system.

As described herein, for any system described herein, the software module may be hardware-agnostic and scalable, such that it may be configured to be in communication with any number of motion controllers, having any number of motion devices coupled thereto (e.g., any number of axes for motor controllers, any number of actuators for pneumatic controllers). For example, the software module may be configured to be in communication, and provide motion sequences for 1, 2, 3, 4, 5, 8, 10 or more pneumatic actuators and 1, 2, 3, 4, 5, 8, 10 or more motorized axes per controller (and/or across multiple controllers).

In some embodiments, only those motion devices that have been setup will be made available. For example, if a motor controller has multiple axes, but axis “A” is setup (e.g., via the setup module, and/or during the initializing block 1709), then only axis “A” will be available to be selected with function blocks (even if axes “B”-“D” have motion devices coupled to the motor controller).

As depicted in FIG. 17, the motion sequence 1704 includes multiple function blocks (e.g., 1706, 1708, 1710, 1712, 1714) organized in a hierarchical arrangement, thereby generating the motion sequence with a number of sequential actions. The function blocks were added to the motion sequence via master blocks 1705, which include setup blocks, programmer blocks, pneumatic blocks, and motor blocks. Each said master block may correspond to the available function blocks, and the associated components, parameters, and/or conditions that may be added to a motion sequence. As described herein, FIG. 20A provides an example (2004) of available components, conditions, and/or parameters for the setup block, FIG. 20B provides an example (2008) of available function blocks, components, conditions, and/or parameters for the motor block, and FIG. 20C provides an example (2010) of available function blocks, components, conditions, and/or parameters for the programmer block. For example, if a function block for actuating the linear slide is desired (or other motor related action), the motor blocks may be selected, thereby providing options as to the available actions (e.g., function blocks) that can be added to the motion sequence. This is similar if a function block for actuating a cylinder is desired, where the pneumatic blocks are selected. Selecting the setup blocks allows for additional parameters and/or other conditions to be specified (e.g., stored into the setup module). Selecting the programmer blocks allows for logic and/or control actions to be specified (e.g., stored in the logic module). An I/O master block may include the parameters and/or conditions for I/O devices to be specified (see 2002 in FIG. 20A). In each case regarding the master blocks, the desired function block may be dragged and drop onto the motion sequence 1704 hierarchy. In some cases, when the function block is properly positioned in the motion sequence, it “snaps” into place with an audible click, thereby signifying it is now part of the executable sequence.

As depicted, the function blocks may be defined by certain parameters that may be entered manually. For example, for function block 1708, “Cylinder 1” 1716 is able to be selected to be actuated from a dropdown selection, and the action is selected to be retracted 1718 (also from a dropdown selection). On the other hand, with respect to function block 1710, a specific numerical value for speed 1720 may be entered.

Once the motion sequence is completed, the software module 1502 is configured to send instructions (e.g., commands) to the motion controller(s) so as to actuate the motion devices to move according to the motion sequence. As described herein, a verification step may occur to ensure the parameters are in line with conditions as set out, and/or there are no missing or invalid parameters.

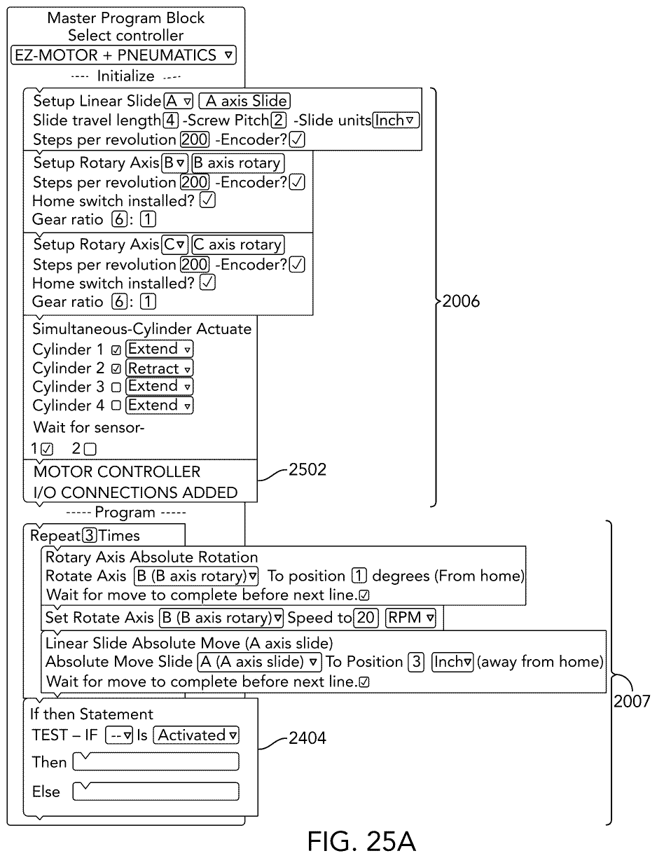

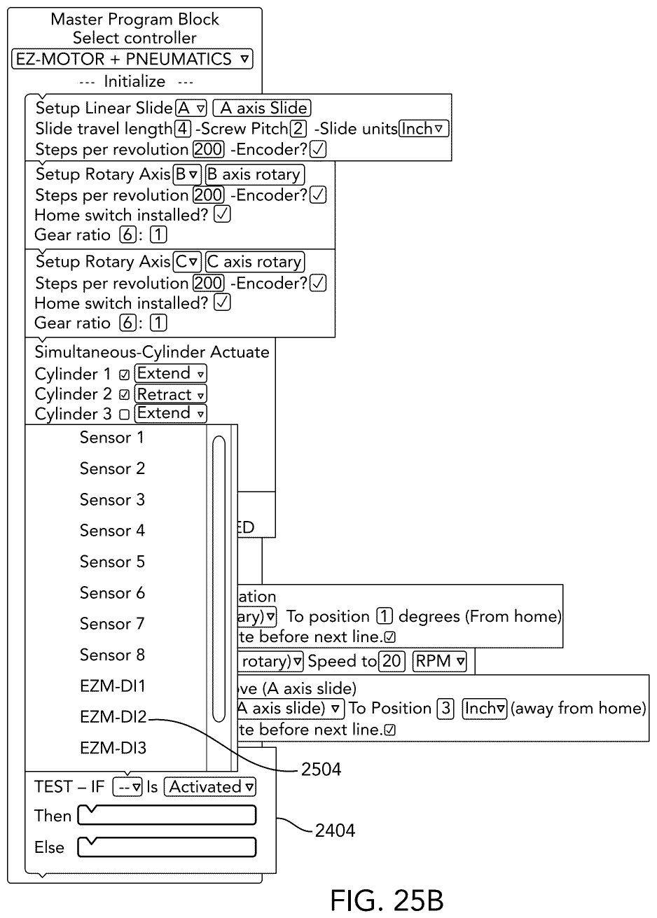

As described herein, the software module is architected such that the number of controllable inputs and outputs is not limited by software structure, but by: i) the number of available I/O addresses (e.g., ports) exposed by the connected controllers, and ii) the controller network topology. The software module may be configured to communicate with each controller over a hardwire connection (e.g., Ethernet cable) using a distributed node model. As described herein, multiple motion controllers may be daisy-chained and/or networked together. Each motion controller may be configured to automatically register available inputs and outputs (e.g., available ports) when initialized (e.g., when communicatively coupled with the software module), and these become selectable options (e.g., via dropdown menus) within the programmer module 1608 and corresponding visual interface (see 2504 in FIG. 25B for example, relating to available I/O ports for a given motion controller). Accordingly, the system may be configured to scale to dozens of outputs (motors or pneumatic actuators) and hundreds of inputs, limited only by available Ethernet bandwidth and controller addressing. As such, the user experience remains the same regardless of I/O count—each device simply appears as an additional selectable axis, actuator, sensor, or other device in the function block interface. Thus, higher-channel controllers, including 8-axis, 16-axis, or more, may be supported by the software module.

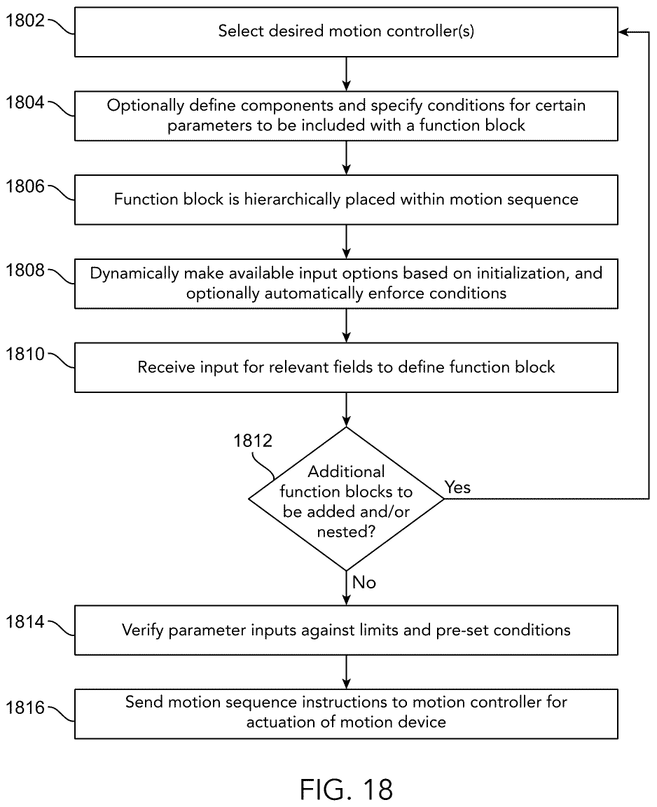

FIG. 18 depicts a flow chart of an example method for generating a motion sequence, via a system described herein, according to some embodiments. FIGS. 19A-25B further illustrate a depiction of a visual interface (e.g., in communication with the programmer module 1608) of at least some of the method steps depicted in FIG. 18, as described herein. As illustrated and described for FIGS. 18-25B, systems and methods described herein are configured to modularly and graphically generate one or more automation sequences, such as a motion sequence and/or other device sequence (e.g., sensor sequence). Such sequence(s) may include a number of function blocks, each defining a number of parameters. Such parameters may be pre-populated by the software module, and/or may be inputted (e.g., by a user, via a user interface). Accordingly, such sequence(s) may be generated without any need for programming, or coding, thereby facilitating a simple interface for a quick assembly of the function blocks, to be carried out by a controller for actuation of a device (e.g., a motion device, as described herein).

In some embodiments, the desired motion controllers may first be selected 1802 in order for the motion sequence(s) to be generated. As described herein, this may be a part of an initialize phase, where the software module may be configured to automatically discover and register the motion controllers that the software module is communicatively coupled with. For example, FIG. 19A depicts a dropdown menu 1901 for selecting a controller, where a pneumatics controller is selected. Similarly, in FIG. 19B, a combination of motor and pneumatics controller is selected from the dropdown menu 1902. In some cases, the desired controller(s) may be selected through an identifier, such as a name, IP address, sequential order in the daisy chain link, etc. For example, where there are multiple controllers of each type, FIG. 19C depicts an example where the number of pneumatic controllers is specified 1904 (e.g., via the visual interface, via the programmer module) as 2, where the software module may list the number of pneumatic controllers available in a dropdown menu. In some cases, the software module may be configured to provide an error or alert upon verifying whether the number of controllers selected matches the number of controllers available (e.g., at the verification step 1814). As depicted in FIG. 19C, the desired pneumatic controllers may be specified based on the respective internet protocol (IP) address 1906 (of the desired controller). Accordingly, the software module is configured to receive and/or send instructions for the respective controllers via the specified identifiers.

Similarly, FIG. 19C depicts the number of desired motor controllers 1908 to be part of a motion sequence, and the specified IP address 1910 (which may help the software module to further identify the desired motor controller if there are multiple motor controllers).

Alternatively or additionally, including embodiments with an automation sequence other than a motion sequence (e.g., a sensor automation), the selected devices may include selecting a specific I/O device.

For the remainder of the steps in FIG. 18, and FIGS. 20A-25B, the controllers selected are the motor and pneumatic controller.

As described herein, the initialize phase may first occur where motion controllers and/or associated I/O devices may be discovered and/or registered by the software module once communicatively coupled with each other (e.g., via hardwire linkage, such as daisy-chain linkage, and/or wirelessly). Once the desired controllers are selected (e.g., FIGS. 19A-19C), the initialize phase may also include specifying 1804 motion devices (e.g., axes and/or cylinders to be actuated) and/or conditions of the selected motion controller(s) that are communicatively coupled with the software module (e.g., as described for motion controller module 1602).

In some cases, the one or more master blocks 2002 (which may be similar to master blocks 1705 in FIG. 17) may define parameters and/or components correlating to specific devices of the controller, motion devices, and/or I/O devices. Each master block 2002 may correlate with a module described herein. For example, the motion controller module 1602 may correlate with the master blocks 2002 for motor blocks and pneumatic blocks. As depicted in FIGS. 20B, 2008 represents an example of the available parameters and components for the motor blocks, which include for example, setting the axis for linear slide motion, choosing speed and/or how much to move, as well as selecting which axis will be rotary, and how much to rotate. Accordingly, the motor and/or pneumatic blocks may provide an interface for accessing the available related motor controller and/or pneumatic controller components for a given automation sequence (e.g., motion sequence). As further depicted in FIG. 20B, the software module may be configured to automatically present a description of a given parameter (e.g., see 2011).

The master blocks 2002 for I/O blocks may correspond to the I/O module 1604, where specific criteria relating to specific I/O devices connected to a specific controller may be found, and/or specified. In some cases, the software module is configured to automatically determine the number of I/O devices connected and/or the number of I/O ports available for a given controller. Accordingly, a specific I/O port, as made available by the software module (e.g., via the visual interface), may be selected for a specific function. Alternatively or additionally, the software module may be configured to determine whether a selected I/O port does not have an I/O device connected thereto via the verification step 1814.

The master block 2002 for programmer blocks may correspond to the logic module 1607, where commands such as wait, wait for user, repeat, if-then, and/or others may be specified, and/or accessed for use in a given automation sequence (e.g., motion sequence, sensor sequence). FIG. 20C depicts an example (2010) of the available conditions to be selected under the programmer blocks.

The master block 2002 for the setup blocks may correspond to the setup module 1606, where specific components and criteria may be prepopulated prior to generating the respective automation sequence(s). As depicted in FIGS. 20A, 2004 provides examples of available criteria, parameters, and/or components that may be prepopulated and/or defined prior to defining the respective function blocks. For example, if I/O devices are added to a respective controller, these may be specified. Certain sensor criteria, such as sensor timeout may be specified.

Moreover, via the setup blocks (e.g., setup module), the type of axes for the motor controller may also be specified (e.g., which axis is a linear slide, and which is rotary). Specific information for each type may also be specified, such as slide travel length, screw pitch, units, steps per revolution, and/or presence of an encoder, As such, this information may be considered by the software module, in real-time when defining the function blocks, and/or at the verification step 1814, so as to ensure a linear move distance does not exceed the slide travel length. The software module may be configured to automatically calculate the maximum length in a given units. Similarly, the rotary axis may be specified, as well as steps per revolution, encoder presence, gear ratio, and/or installation of a home switch.

As described herein, during the initialize stage, certain components may be defined and/or certain conditions may be specified 1804. Such desired specifications may be graphically, and/or modularly added to an initialize block 2006 (see FIG. 20A). FIG. 21 depicts an initialize block 2006 where certain desired parameters have been modularly (and/or graphically) added to the initialize block, where such parameters may be part of a function block to be defined. This includes a linear axis slide that has been specified as axis A (2102) for the respective motor controller and/or a specific length, and two rotary axes that have been specified as axis B (2104) and C (2105) for the respective motor controller, with a specific gear ratio. Moreover, though not found in the setup blocks 2004, pneumatic controller components were also added to the initialize block 2006, such as specifying the initial position of specific cylinders (2106). Accordingly, certain components and parameters from the master blocks 2002 may also be added to the initialize phase.

The initialize block and/or setup conditions in step 1804 may be optional, as the master blocks may allow for the respective function blocks to be selected, defined, and specified as part of the sequence generating block 2007 (see. FIG. 20A).

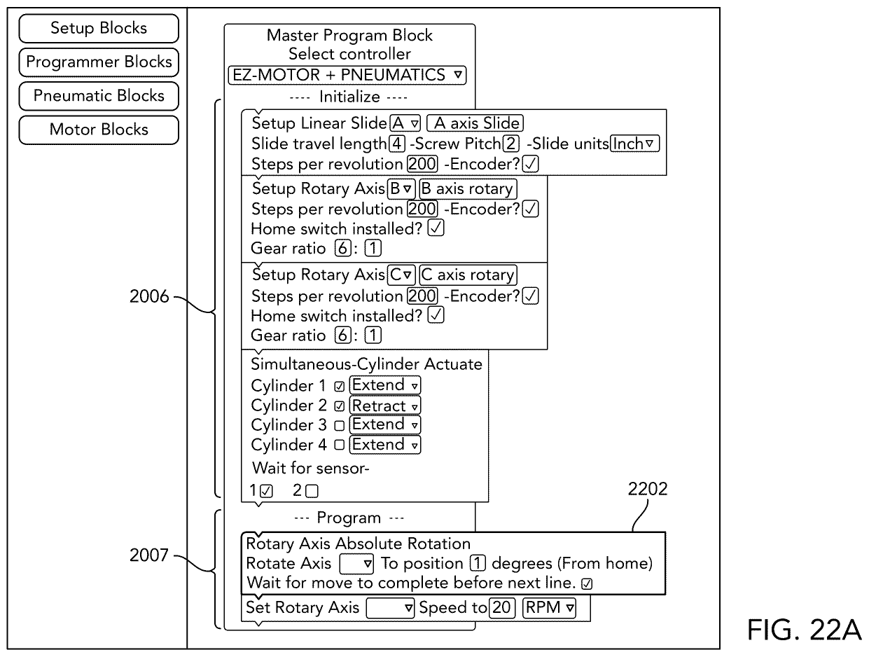

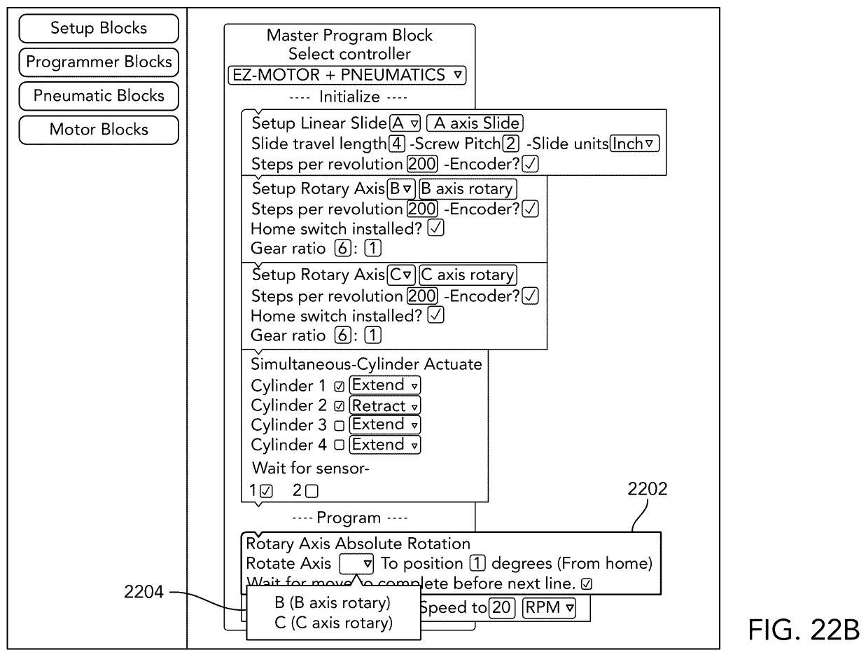

Any number of function blocks may be hierarchically placed 1806 into the sequence generating block 2007, so as to be a part of an automation sequence (e.g., motion sequence). For example, as depicted in FIG. 22A, a rotary movement function block 2202 is added to the sequence generating block 2007. The function block may simply be dragged and dropped into the sequence generating block. The function block, as described herein, includes one or more parameters that further define the action to be performed (e.g., here rotation of a motion device).

The software module, via the motion controller module, the setup module, the I/O module, and/or the logic module, (and/or during the initialize phase, as described herein), may dynamically make available 1808 options for certain inputs to be selected, and/or may automatically enforce certain conditions (e.g., travel limit for linear slide). For example, with respect to FIG. 22B, when choosing which axis as being rotary, only axis B or C is available (2204) to be selected (e.g., from a dropdown menu). This restriction of axes to select for rotation may have been automatically and/or dynamically specified upon the setup module receiving the information defining which axes were to be rotary (e.g., during the initialize stage—see FIGS. 21, 2104 and 2105 for example).

As another of such dynamic enforcement of conditions, if a “Setup Linear Slide” block defines Motor A with a 200 mm stroke and encoder feedback, then “Motor A” will appear in the dropdown menus of subsequent motion function blocks, with position limits automatically enforced. Alternatively or additionally, such position limits may be flagged during the verification step 1814, as described herein.

In some cases, the software module automatically removes certain inputs that would normally be available for a function block, based on any existing conditions in place (e.g., if-then action). Some inputs are only shown if others are selected. For instance, checking “Wait for Sensor” in a function block reveals additional options for which sensor to monitor and what timeout to apply. Accordingly, this adaptive input structure may help ensure that the user only sees relevant fields for each action, thereby helping simplify the workflow and preventing or reducing the risk of conflicting parameter combinations.

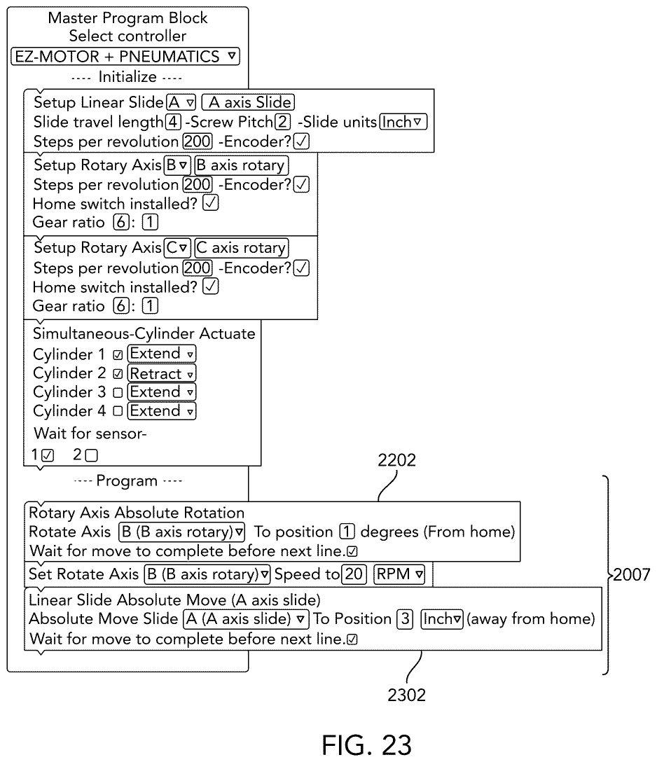

The software module may receive input 1810 for certain conditions and parameters associated with the function block. As described herein, such input may be received via dropdown selections, text fields, unit selectors, and/or checkboxes. In FIG. 23, the input received for the rotary movement function block 2202 include the rotary axis selection as the B-axis, and the position from home.

Examples of inputs for a linear slide move function block may include selecting the motor axis (A-D), entering a target position, selecting units (mm/inches), and/or specifying a speed. Examples of inputs for an actuate cylinder function block (e.g., for pneumatic controller) may include selecting the cylinder number (1-4), choosing extend/retract, and optionally checking “Wait for Sensor.” Examples of inputs for an “If Then” block may include selecting which input sensor to evaluate and/or defining its logical condition (activated/deactivated).

Upon a function block being defined with the available inputs, additional function blocks may be added 1812 to the motion sequence, either as a subsequent function block, or as a nested function block within the original function block. Such additional function blocks may be added to the motion sequence in a modular arrangement. If an additional function block is added, then steps 1806-1812 may repeat.

For example, as depicted in FIG. 23, another function block, linear slide absolute move (2302), was added to the automation sequence (e.g., motion sequence). The linear slide function block 2302 was graphically added, below the rotary function block 2202. For example, the linear slide function block 2302 may have been simply dragged from the motor blocks options (e.g., 2008 in FIG. 20B), and dropped in the sequence generating block 2007.

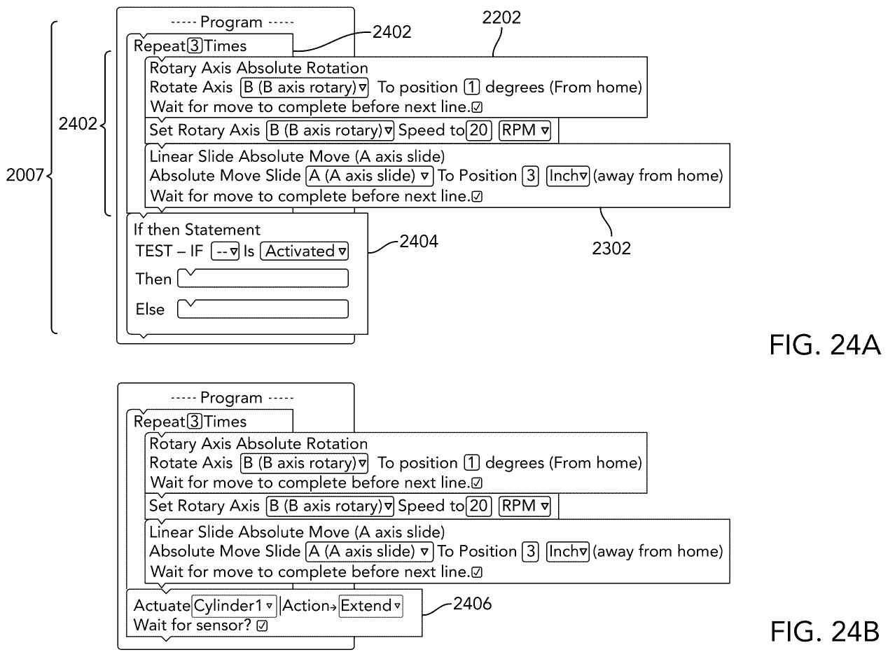

As depicted in FIGS. 24A-24B, additional function blocks may be graphically and modularly added to the automation sequence. For example, as depicted in FIGS. 24A-24B, the rotary axis movement function block 2202 and linear axis movement function block 2302 from the motion sequence in FIG. 23 are nested within a repeat function block 2402, where the rotary and linear motion is specified to be repeated 3 times.

Additionally, in FIG. 24A, an if-then function block 2404 has been added to the motion sequence, occurring after the repeat function block action has been completed, while in FIG. 24B, a cylinder actuation function block 2406 has been added to the motion sequence, occurring after the repeat function block action has been completed. Both of these additional function blocks 2404, 2406 may be accessed from the respective master blocks 2002. The cylinder actuate function block 2406 may dynamically receive information relating to the initial position of a respective cylinder based on the initialize block 2006.

Similarly, as depicted in FIGS. 25A-25B, I/O devices may be added to the initialize block 2006, which then may dynamically make available certain I/O devices in the sequence generating block 2007, when defining a function block. For example, FIG. 25A depicts that I/O connections for the selected motor controller are included 2502 with the initialize stage. Accordingly, the I/O ports and connections will automatically be available to be selected for a corresponding function block. As depicted in FIG. 25B, which includes the if-then function block 2404 (FIG. 24A), the available I/O ports 2504 include EZM-D11, D12, and so on, where such ports are only available to the motor controller.

Once the final function block has been defined (e.g., the respective parameters have been populated and/or specified with corresponding data, to be included with the motion sequence), the software module automatically performs a verification 1814 of the parameter input(s). Such verification may include automatically cross-checking entered values (e.g., ensuring a move position does not exceed the slide's configured length, or timeout values are within allowable ranges), and/or identifying any invalid or missing inputs. Any issues identified via the verification step may prevent the motion sequence(s) from being saved until corrected. Alternatively or additionally, the verification may occur after the file has been saved, and upon execution of the commands.

Once all function blocks have been defined, the software module is configured to store the generated motion sequence(s), which may be executed as code and sent 1816 to the motion controller(s) to actuate the respective motion devices for movement according to the specified motion sequence(s).

Alternatively or additionally, for a sensor controller, the sensor may be triggered so as to actuate an action (as described herein).

The software module may be configured to communicate concurrently with all discovered and/or selected motion controllers via the active communicative link (e.g., Ethernet daisy-chain). The software module may send the same sequence to each motion controller, wherein each motion controller may be configured to execute only the commands relevant to its configured devices (e.g., the motion devices and/or I/O devices coupled thereto).

Either E-Stop (motor or pneumatics) can stop the entire sequence, though each de-energizes only its own hardware domain. Thus, multiple controllers behave as independent subsystems under synchronized command, enabling complex coordinated motion across multiple hardware types.

The software module may also save the generated motion sequence(s). In some cases a .txt file is saved and used by the software module to execute the motion sequence(s). In some cases, an .xml file is saved, which defines the program's structure and retains all user-specified inputs for future editing.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “substantially” refers to less than or equal to +/−1%, +/−2%, +/−3%, +/−4%, +/−5%, +/−6%, +/−7%, +/−8%, +/−9%, +/−10%, +/−11%, +/−12%, +/−14%, or +/−15% variation. As a non-limiting example, substantially parallel represents a range of −1 to 1 degree difference, −5 to 5 degree difference, or −15 degrees to 15 degrees of difference from being parallel, depending on the embodiments. In another example, the term “substantially” may refer to “completely” or “nearly completely.”

As used herein, the terms “generate” (and variations thereof) and “define” (and variations thereof), may, in some cases, be used interchangeably.

The foregoing may be accomplished through software code running in one or more processors on a communication device in conjunction with a processor in a server running complementary software code.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

It is appreciated that in order to practice the method of the foregoing as described above, it is not necessary that the processors and/or the memories of the processing machine be physically located in the same geographical place. That is, each of the processors and the memory (or memories) used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the foregoing, be performed by a single component. Further, the processing performed by one distinct component as described above may be performed by two distinct components. In a similar manner, the memory storage performed by two distinct memory portions, as described above, may, in accordance with a further embodiment of the foregoing, be performed by a single memory portion. Further, the memory storage, performed by one distinct memory portion, as described above, may be performed by two memory portions.

Further, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the foregoing, a variety of “user interfaces” may be utilized to allow a user to interface with the processing machine or machines that are used to implement the foregoing. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the foregoing, it is not necessary that a human user actually interact with a user interface used by the processing machine of the foregoing. Rather, it is also contemplated that the user interface of the foregoing might interact, i.e., convey and receive information, with another processing machine, rather than a human user. Accordingly, the other processing machine might be characterized as a user. Further, it is contemplated that a user interface utilized in the system and method of the foregoing may interact partially with another processing machine or processing machines, while also interacting partially with a human user.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1. A system, comprising
a controller configured to actuate movement of a motion device;
one or more processors; and
one or more memories storing instructions that, when executed by the one or more processors, cause the system to perform operations comprising:
generating a motion sequence, by:
defining, via communication with the controller, one or more function blocks for the motion sequence, each function block defined by one or more parameters; and
receiving an input for the one or more parameters of each function block of the one or more function blocks; and
sending, to the controller, instructions relating to the one or more parameters, so as to actuate the movement of the motion device in accordance with the motion sequence.

2. The system of claim 1, wherein each function block of the one or more function blocks corresponds to an action performed by the i) the controller, ii) the motion device, iii) an external component coupled with the controller, or iv) any combination thereof, such that the one or more function blocks correspond to one or more actions.

3. The system of claim 2, wherein each action comprises a motion action, a conditional action, a wait action, a repeat action, or any combination thereof.

4. The system of claim 3, wherein the motion sequence is generated via modularly arranging the one or more function blocks in a hierarchical order, via a graphical user interface.

5. The system of claim 4, wherein the hierarchical order corresponds to a sequential performance of the corresponding one or more actions.

6. The system of claim 4, wherein modularly arranging the one or more function blocks comprises a drag-and-drop configuration.

7. The system of claim 1, wherein receiving the input for each parameter of the one or more parameters is via i) input received from a user, ii) automatically correlated with the parameter based on preconfigured initialized data, or iii) both.

8. The system of claim 7, wherein the preconfigured initialized data corresponds to a property relating to the controller, the motion device, a device coupled to the controller, or any combination thereof.

9. (canceled)

10. The system of claim 8, wherein preconfigured initialized data comprises a real-time binding with function block defined for the motion sequence, such that changes to the preconfigured initialized data are automatically changed for the corresponding function block.

11. The system of claim 2, wherein the controller comprises a motor controller, a pneumatic controller, or both.

12. The system of claim 11, wherein the motion device comprises a motor controlled device in communication with the motor controller.

13. The system of claim 12, wherein the motor controlled device comprises a linear slide, a rotary index, or both.

14. The system of claim 13, wherein the action comprises a motion action, the motion action comprising a movement of the linear slide, a rotation of the rotary index, or both.

15. (canceled)

16. (canceled)

17. (canceled)

18. The system of claim 12, wherein the input comprises a corresponding axis for the motion device, a motion type, an absolute target position, units of measurement for a motion, speed, acceleration, direction of motion, rotation speed, rotation amount, rotation units, timeout duration, encoder presence, gear ratio or pitch, steps per revolution, home switch configuration, homing method, or any combination thereof.

19. The system of claim 11, wherein the motion device comprises a pneumatic controlled device in communication with the pneumatic controller.

20. The system of claim 19, wherein the pneumatic controlled device comprises a pneumatic cylinder.

21. The system of claim 20, wherein the action comprises a motion action, the motion action comprising an extension or retraction of the pneumatic cylinder.

22. (canceled)

23. (canceled)

24. The system of claim 19, wherein the input comprises cylinder selection, extension or retraction action by the cylinder, pressure condition, or any combination thereof.

25. The system of claim 2, wherein the controller is communicatively coupled with the external component, wherein at least one function block of the one or more function blocks corresponds to an action performed by the external component.

26. (canceled)

27. The system of claim 25, wherein the external component comprises a sensor

28.-79. (canceled).
